(19) United States
(12) Patent Application Publication
(10) Pub. No.: US 2016/0110522 A1
(43) Pub. Date: Apr. 21, 2016

(54) Mapping Tools for Health or Fitness Data

(71) Applicant: AddApp Corp., San Francisco, CA (US)

(72) Inventor: Kouris Kalligas, San Francisco, CA (US)

(21) Appl. No.: 14/883,141

(22) Filed: Oct. 14, 2015

Related U.S. Application Data
(60) Provisional application No. 62/064,006, filed on Oct. 15, 2014.

(51) Int. Cl. G06F 19/00

(52) U.S. Cl. CPC G06F 19/3481; G06F 19/322; G06F 19/3487

(57) ABSTRACT

First and second health and wellness metrics are collected with first and second mobile applications, respectively. A hub mobile application normalizes the first and health and wellness metrics into first and second primitive metrics, which are then correlated. Based on the correlation or the value of one or more of the first or second primitive metrics, information is displayed to the user on his or her mobile device. The information can include a graph for a health and wellness metric, a health and wellness tip, a health and wellness insight, a user action for improved health and wellness, and a health and wellness informative article. The determination of which graphs, tips, insights, user actions, and informative articles to show can be based on settings for the correlation or primitive metric(s) value, which may be modified from a server the mobile application(s) may connect to.

### CROSS-REFERENCE

This application claims the benefit of U.S. Provisional Application No. 62/064,006, filed Oct. 15, 2014, which application is incorporated herein by reference.

### BACKGROUND OF THE INVENTION

The present disclosure relates to systems and methods for tracking health and wellness data and providing information, tips, insights, actionable items, and the like therefrom.

Mobile computing devices such as smartphones and wearable devices are increasing prevalent. Such devices have been used by many to track exercise and activity levels, sleep, mood, heart rate, and other metrics of health and wellness. Multitudes of applications or “mobile apps” are available for the tracking of such metrics. Some of these applications also provide tips and tools for improvement of a user's health and wellness.

Such applications and health and wellness tracking systems, however, may be less than ideal in at least some cases. The information may be tracked using different standards for different applications, which may confuse the user and may provide information that is less than accurate when the user relies upon two or more different applications. Also, health and wellness often depends on more than one factor, and many applications may track and analyze health and wellness metrics in isolation. Many of the applications are also “one size fits all” and may not be well catered to the particularities of an individual user's body and medical history.

At least some of the above challenges will be addressed by the embodiments of the present disclosure described below.

### SUMMARY OF THE INVENTION

The present disclosure relates to systems and methods for tracking health and wellness data and providing information, tips, insights, actionable items, and the like therefrom. First and second health and wellness metrics may be collected with first and second mobile applications, respectively. A hub mobile application may normalize the first and health and wellness metrics into first and second primitive metrics, which may then be correlated. Based on the correlation or the value of one or more of the first or second primitive metrics, information may be displayed to the user on his or her mobile device. The information may include a graph for a health and wellness metric, a health and wellness tip, a health and wellness insight, a user action for improved health and wellness, and a health and wellness informative article, to name a few. The determination of which graphs, tips, insights, user actions, and informative articles to show may be based on settings for the correlation or primitive metric(s) value, which may be modified from a server the mobile application(s) may connect to.

Aspects of the present disclosure provide computer implemented methods for managing user health and wellness data. A computing device of a user may receive a first health and wellness metric collected from a first application downloaded onto the computing device. The computing device may receive a second health and wellness metric collected from one or more of the first application or a second application downloaded onto the computing device. The first health and wellness metric may be different from the second health and wellness metric. The second application may be different from the first application. The first and second health and wellness metrics may be normalized into a first and second primitive metric, respectively. One or more of a graph for a health and wellness metric, a health and wellness tip, a health and wellness insight, a user action for improved health and wellness, or a health and wellness informative article may be displayed to the user on a display of the computing device in response to the correlation between the first and second primitive metrics. A correlation may comprise, for example, a relationship between activity and heart rate, activity and blood pressure, activity and sleep, activity and nutrition, nutrition and blood pressure, nutrition and body mass index, and nutrition and sleep, to name a few. Alternatively or in combination, the graph(s), tips, insights, user action(s), and informative article(s) may be provided based on a single health and wellness metric. Such methods may be implemented on a client-side computing device.

Aspects of the present disclosure also provide computer implemented method for managing user health and wellness data. With a computing device such as a server, first and second applications may be selected. The first and second applications may be configured for download to a remote computing device, which may be connected to the remote server through the Internet. With the computing device (e.g., the server), first and second primitive metrics may be selected. These primitive metrics may be normalized from health and wellness metric(s) provided by the first and/or second applications. The process by which the health and wellness metric(s) are normalized may be selected and/or customized with the computing device (e.g., the server) by an administrator thereof who will typically be different from the user of the remote computing device. One or more of a target goal for first and/or second primitive metrics, a correlation parameter for the first and second primitive metrics, a health and wellness tip, a health and wellness insight, a user action for improved health and wellness, or a health and wellness informative article may be input into the computing device (e.g., the server) in response to the first or second primitive metric. Such methods may be implemented on a server-side computing device and may determine what a user of a client-side computing device is displayed from a hub mobile application in response to information and/or inputs from the first and second applications.

Aspects of the present disclosure also provide computer and network systems for implementing one or more of the computer implemented methods described herein.

The computing device of the user may comprise a mobile computing device such as a slate or tablet computer, a smartphone, a personal digital assistant (PDA), a wearable computing device, or the like. Examples of such device include the Apple iPhone, Apple iPad, Apple iPod, Apple Watch, Google Nexus, Google Glass, Samsung Galaxy, Samsung Galaxy Gear, Amazon Fire Phone, and Microsoft Surface, to name a few.

The first and/or second applications may comprise “mobile applications” downloaded from an application distribution platform such as the Apple App Store, Google Play, Amazon Appstore, Microsoft Windows Store, or the like. Examples of such applications may include Apple HealthKit, BodyMedia Fit, Cardiio, Facebook, Calorie Counter by FatSecret, FitBit, Foursquare, iHealth, Jawbone, Magellan GPS or Roadmate, Run with May My Run, Moodpanda, Moves, Runkeeper, Sleep as Android, Sleep Cycle, Strava, and WiThings Apps, to name a few.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “Figure” and “FIG.” herein) of which:

FIGS. 1A to 1O show user interfaces for a client application to track and/or manage health and wellness metrics from various third-party applications, according to many embodiments;

FIGS. 2A to 2N show user interfaces for a server application to manage complementary client application(s) to track, normalize, and/or correlate health and wellness metrics from various third-party applications, according to many embodiments;

FIGS. 3A to 3J show user interfaces for a server application to manage complementary client application(s) to provides tips, insights, instructions, and/or informative articles based on health and wellness metrics from various third-party applications, according to many embodiments; and

FIG. 4 shows a computer system programmed to implement the methods of the present disclosure, according to many embodiments.

### DETAILED DESCRIPTION OF THE INVENTION

While preferred embodiments of the present disclosure are shown and described herein, it will be obvious to those skilled in the art that such embodiments are provided by way of example only. Numerous variations, changes, and substitutions will now occur to those skilled in the art without departing from the scope of the present disclosure. It should be understood that various alternatives to the embodiments of the present disclosure described herein may be employed.

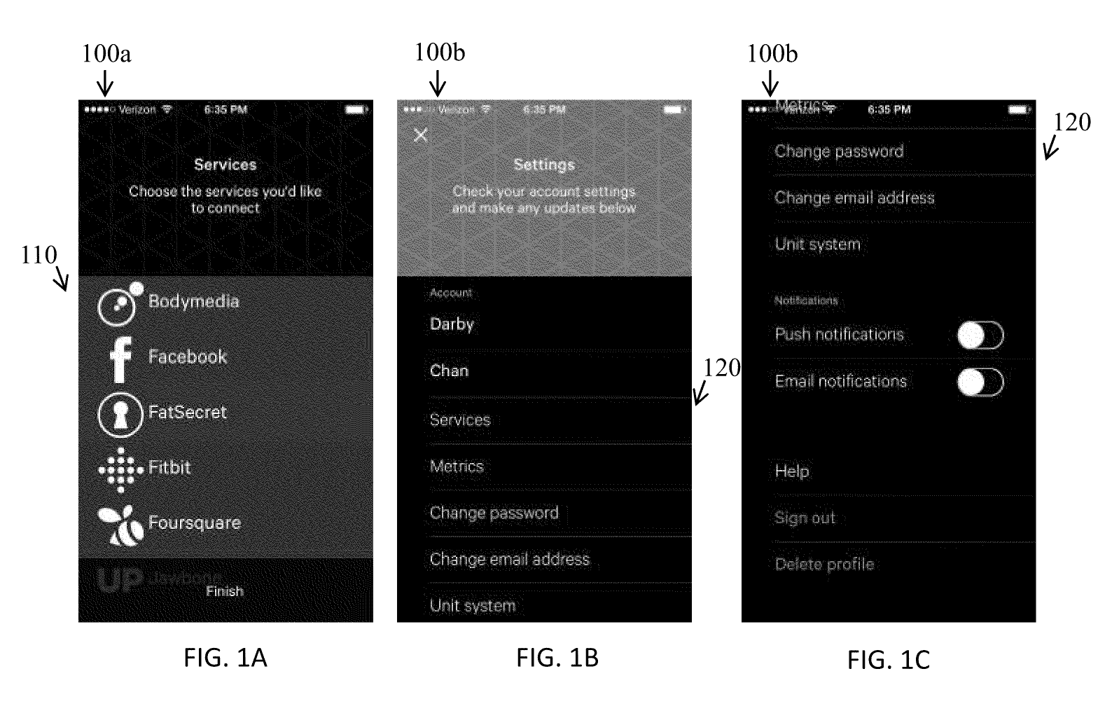

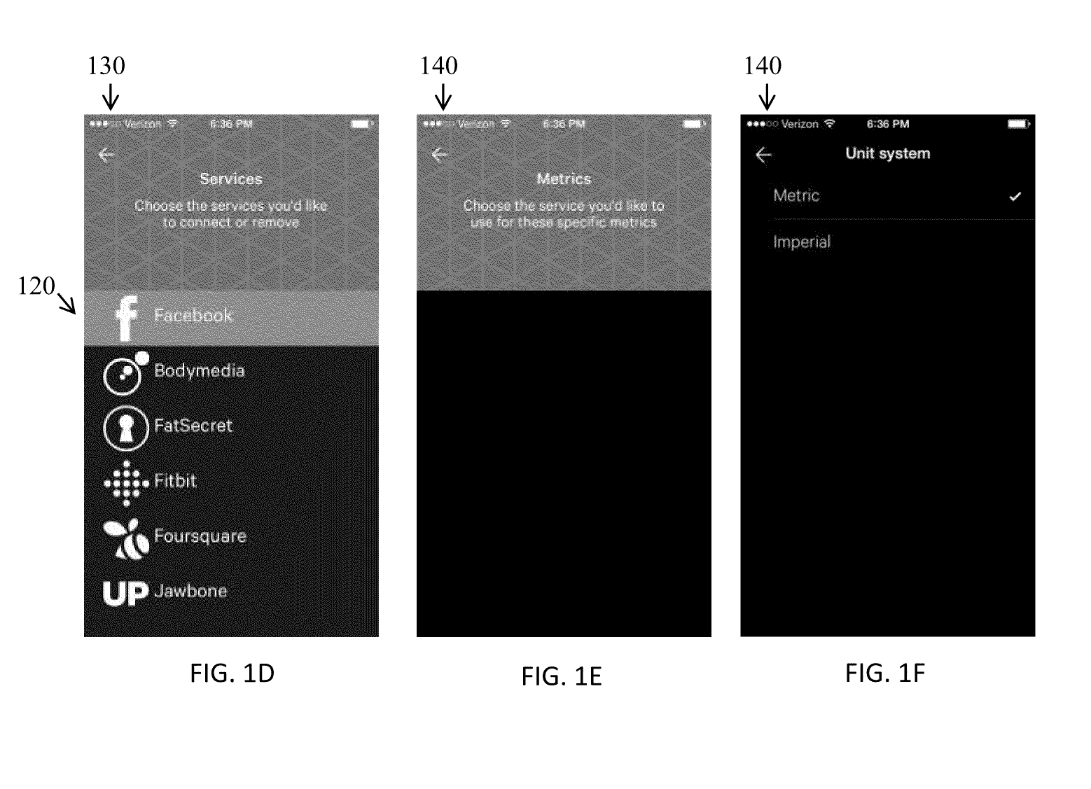

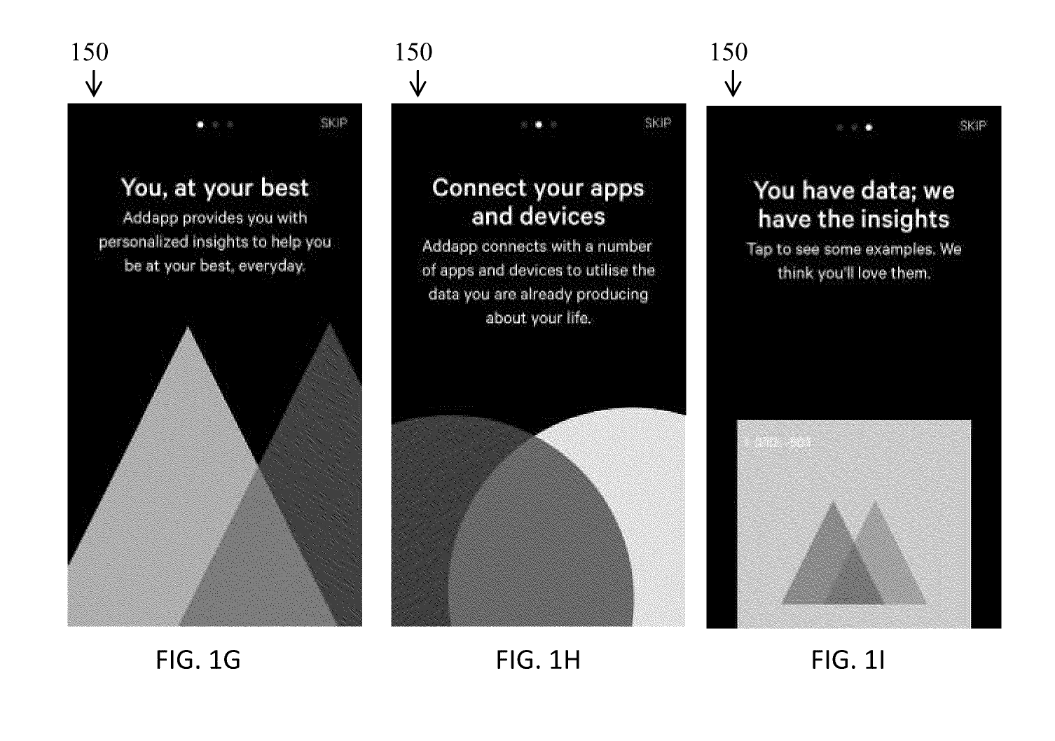

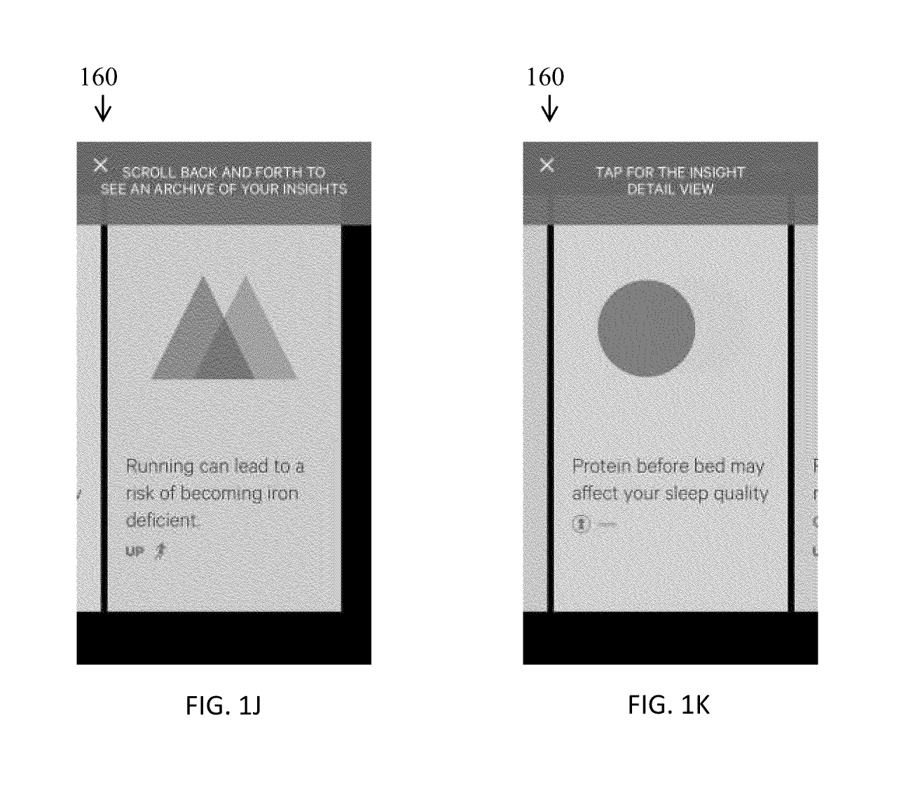

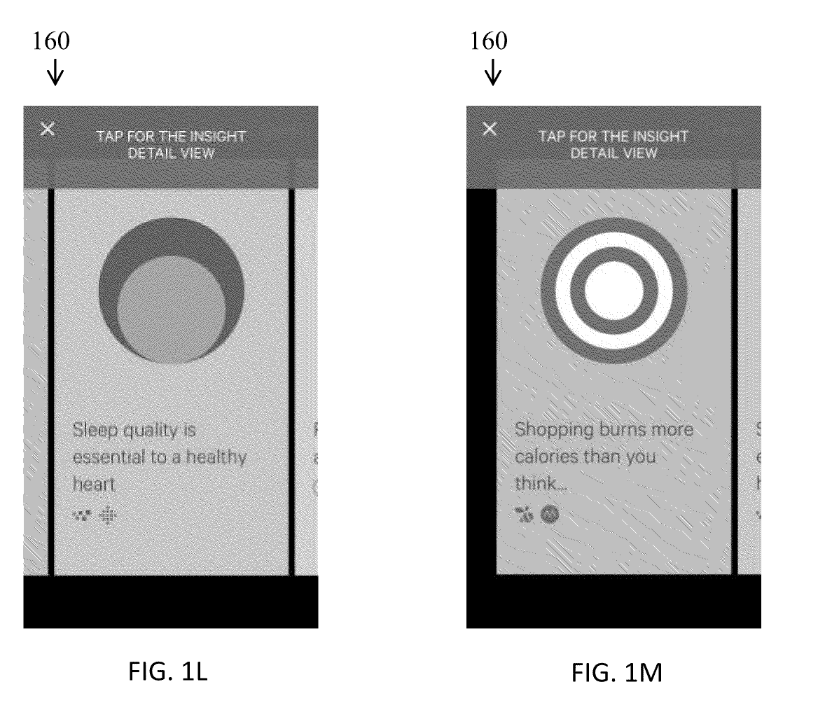

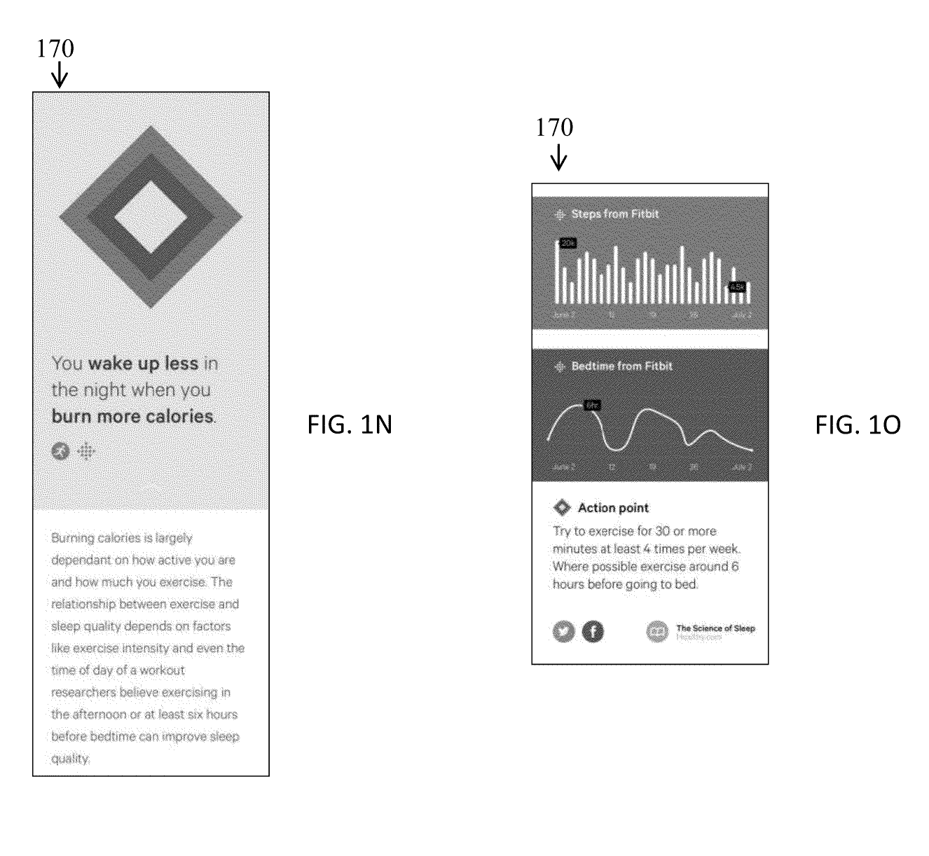

FIGS. 1A to 1O show user interface(s) for a client application to track and/or manage health and wellness metrics from various third-party applications. The client application and/or the third-party application(s) may comprise a “mobile application” downloaded and active on a mobile computing device such as a slate or tablet computer, a smartphone, a personal digital assistant (PDA), a wearable computing device, or the like. Examples of such device include the Apple iPhone, Apple iPad, Apple iPod, Apple Watch, Google Nexus, Google Glass, Samsung Galaxy, Samsung Galaxy Gear, Amazon Fire Phone, and Microsoft Surface, to name a few. The user interface may be provided through the display of the mobile computing device, such as a touch screen display and/or a display responsive to motion detection. The client application may be downloaded from an application distribution platform such as the Apple App Store, Google Play, Amazon Appstore, Microsoft Windows Store, or the like. Examples of such applications may include Apple HealthKit, BodyMedia Fit, Cardiio, Facebook, Calorie Counter by FatSecret, FitBit, Foursquare, iHealth, Jawbone, Magellan GPS or Roadmate, Run with May My Run, Moodpanda, Moves, Runkeeper, Sleep as Android, Sleep Cycle, Strava, and WiThings Apps, to name a few.

FIG. 1A shows a menu 100a for a user to select the third party applications and services 110 the client application will interface with. Typically, these third party applications 110 will provide health and wellness information from the user and/or provide user information such that the third party application 110 can provide input to one or more social networks. Examples of such third party applications 110 include Bodymedia, Facebook, FatSecret, Fitbit, Foursquare, and Jawbone, to name a few. Other examples are further discussed herein.

FIG. 1B and FIG. 1C show a menu 100b for the user to adjust various settings of the client application. The menu 100b may comprise a plurality of buttons 120 to access sub-menus. Through the sub-menus, the user may adjust one or more of which user account to use, which third-party applications and services to interface with, what metrics to keep track of, the password and e-mail address of the user account, which unit system to use (i.e., the metric system or the standard/imperial system), or how the client application provides notification to the user. The menu 100b may further link to a help menu, allow for user account sign out, and/or deletion of the user account.

FIG. 1D shows the services sub-menu 130 having a third-party application 120 selected for interface with the client application.

FIG. 1E and FIG. 1F show the metrics sub-menu 140 selected so that the client application uses the metric system.

FIG. 1G, FIG. 1H, and FIG. 1I show an introduction or a tutorial menu 150 to explain to the user the various benefits and advantages of the client application.

FIG. 1J, FIG. 1K, FIG. 1L, and FIG. 1M show a user interface 160 providing exemplary health and wellness insights to a user. The user may scroll back and forth between the different health and wellness insights. This user interface 160 may comprise one or more buttons which the user may select to access a more detailed health and wellness insight, tip, and/or informative article.

FIG. 1N and FIG. 1O show more detailed health and wellness information screen 170 accessed by the user. The more detailed health and wellness information screen 170 may include a one or more of health and wellness insight, one or more graphs showing tracked health and wellness data from the user (which may be provided from the connected third-party application(s)), or a suggested course of action for the user to improve his or her health and wellness.

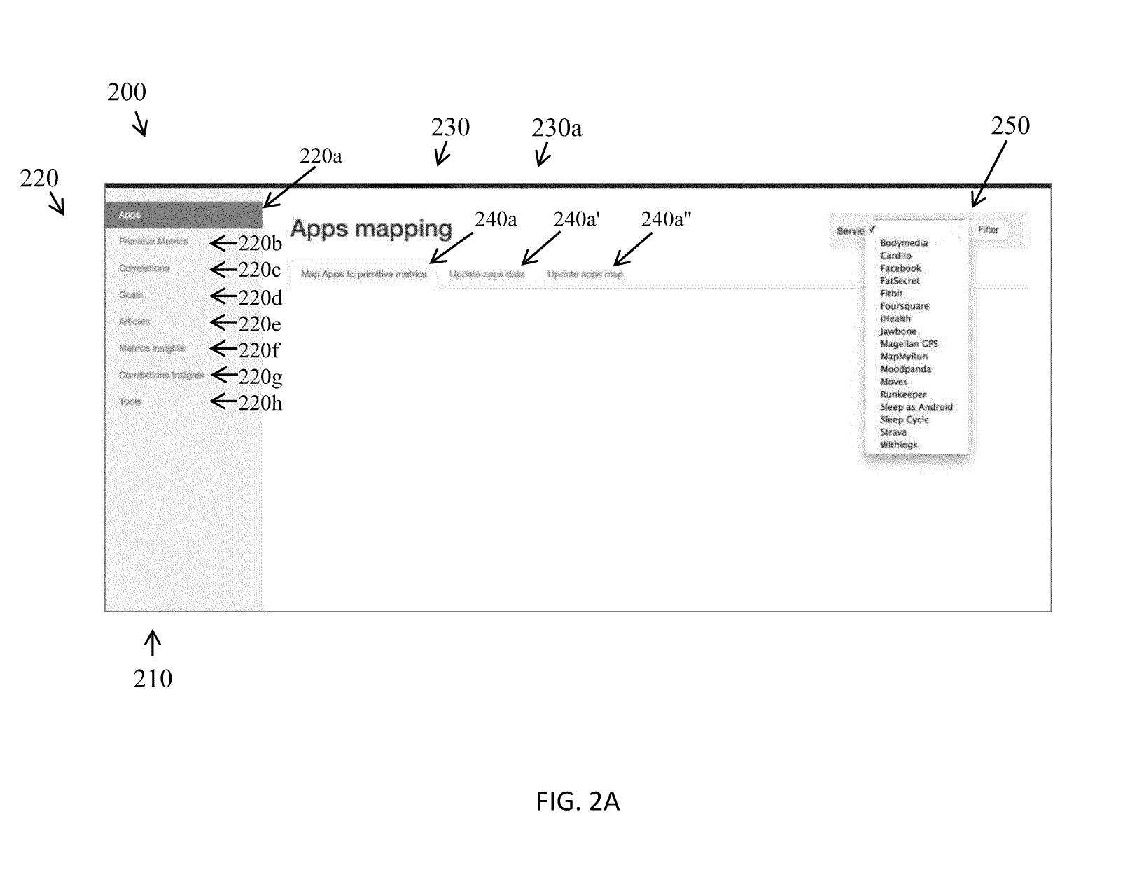

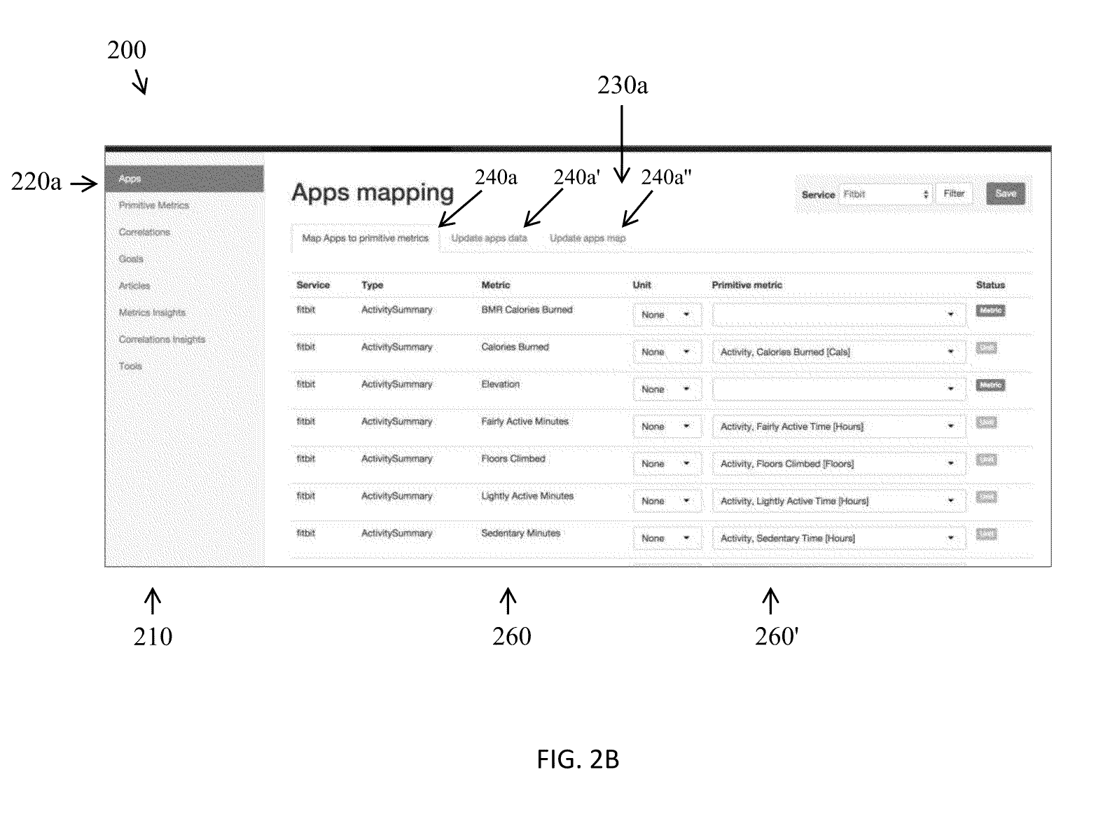

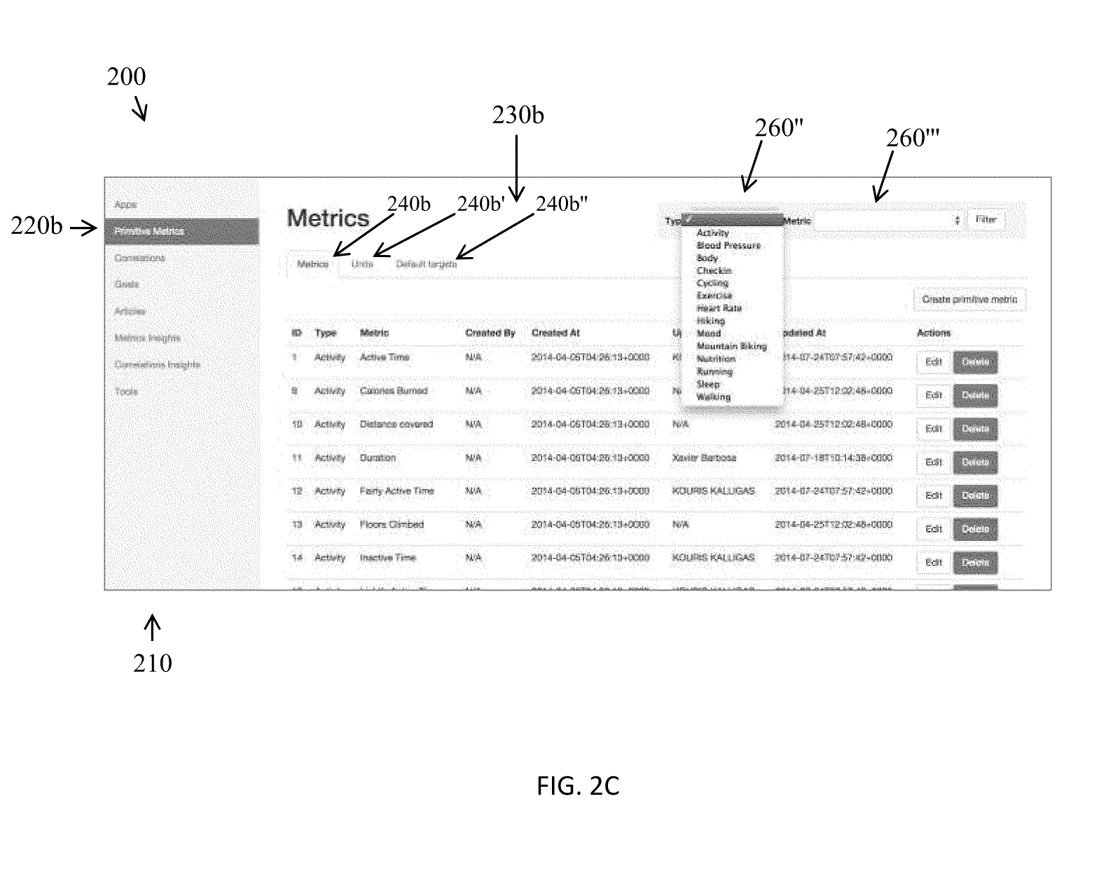

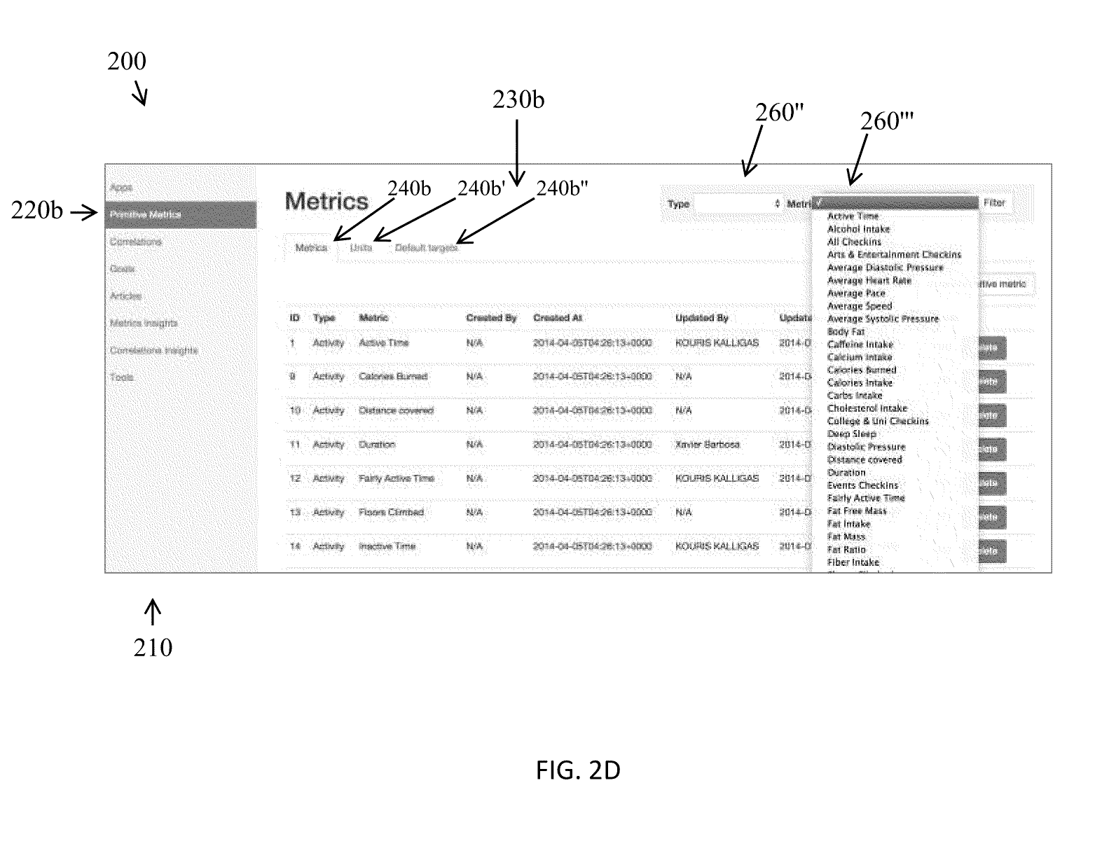

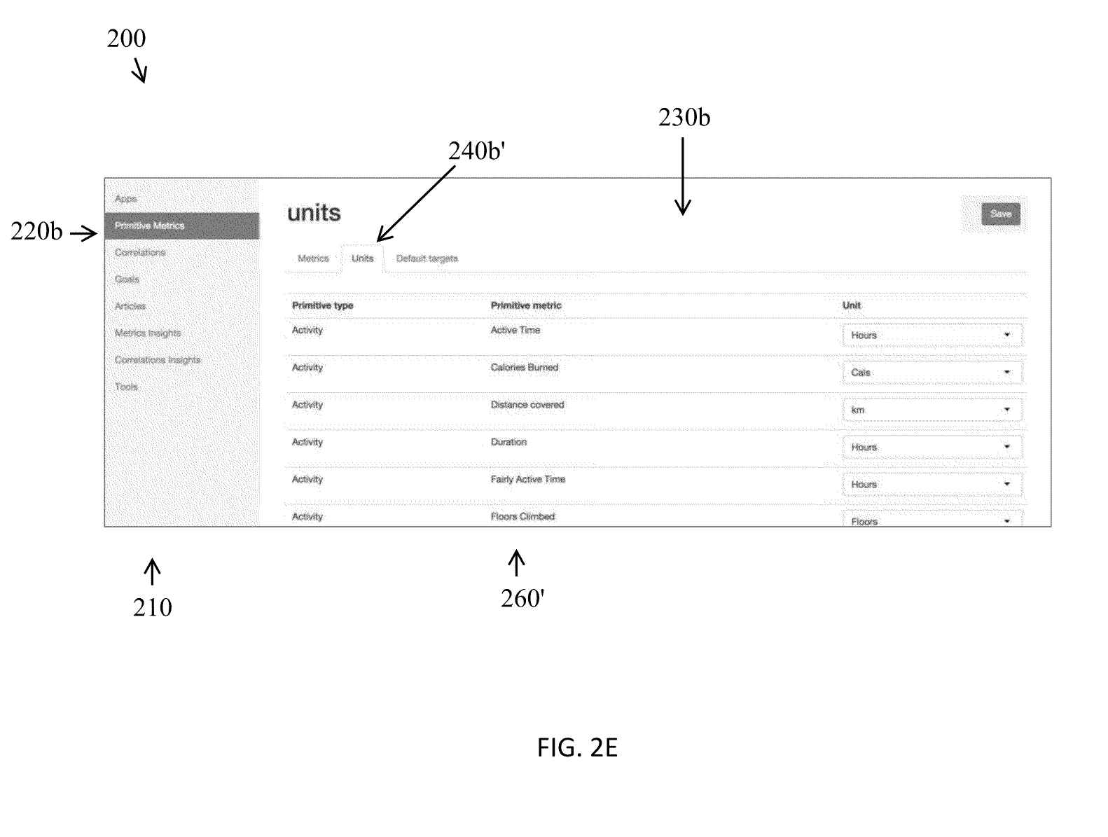

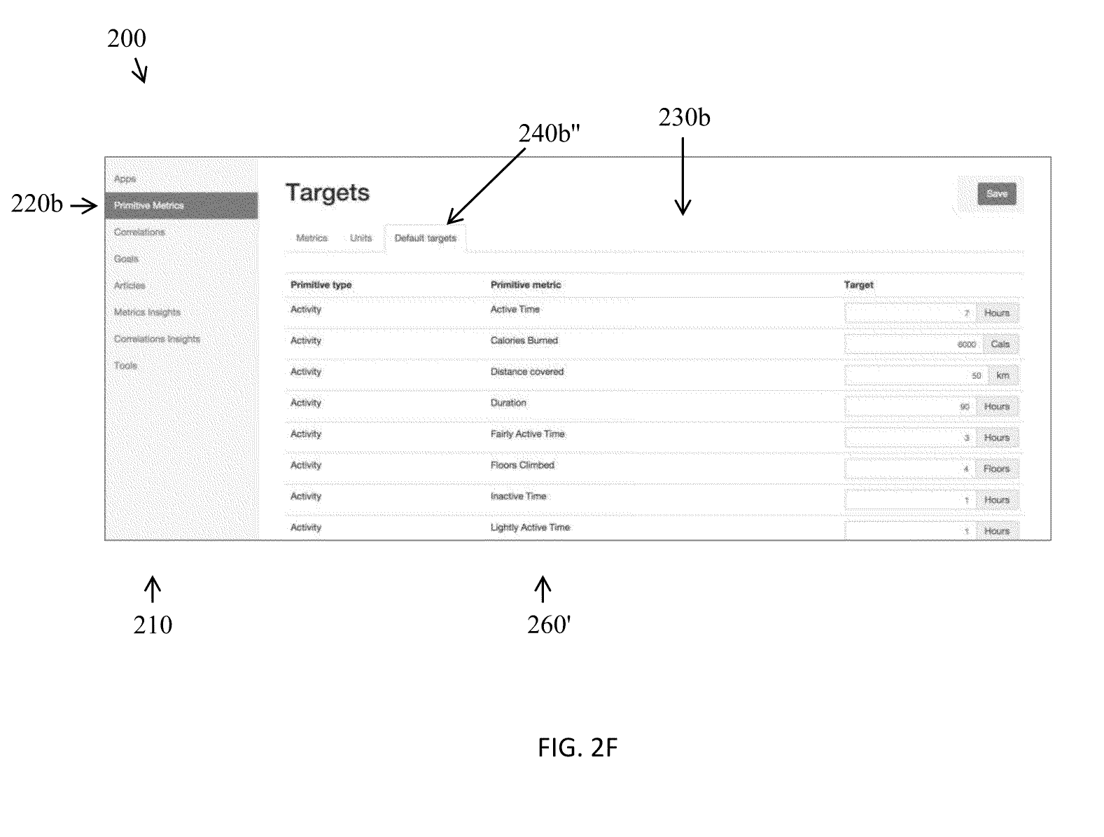

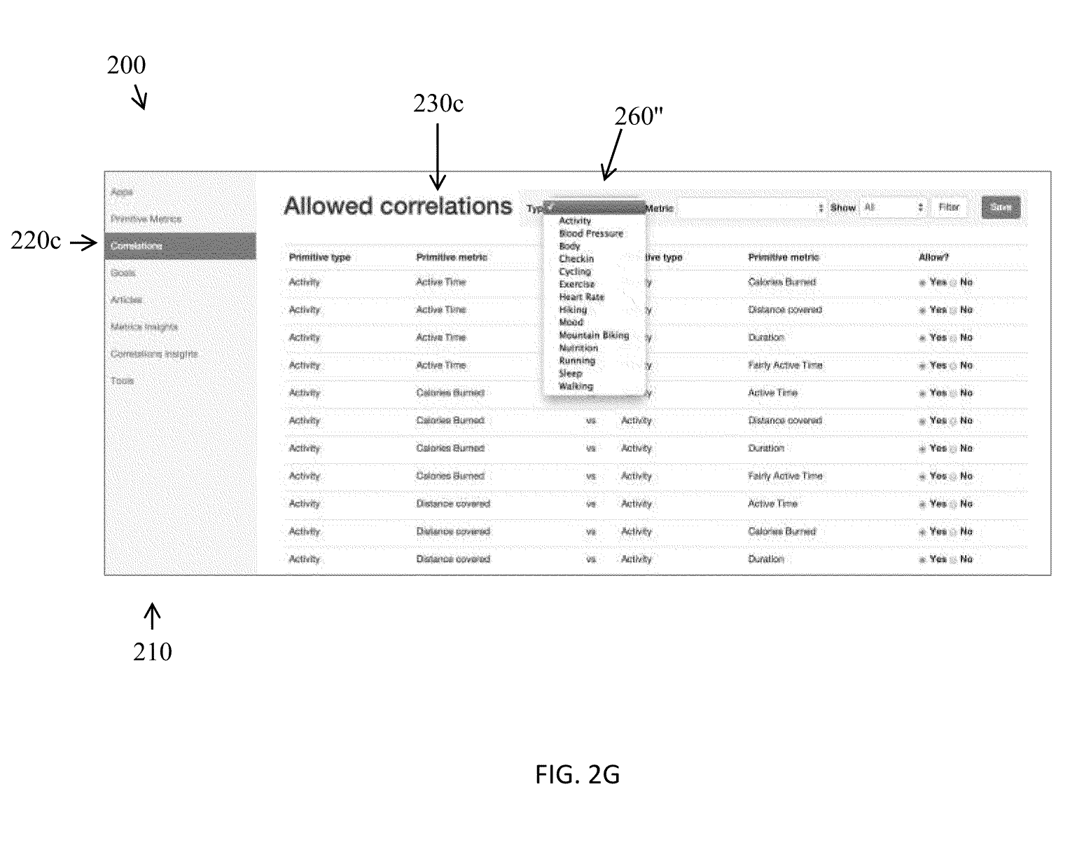

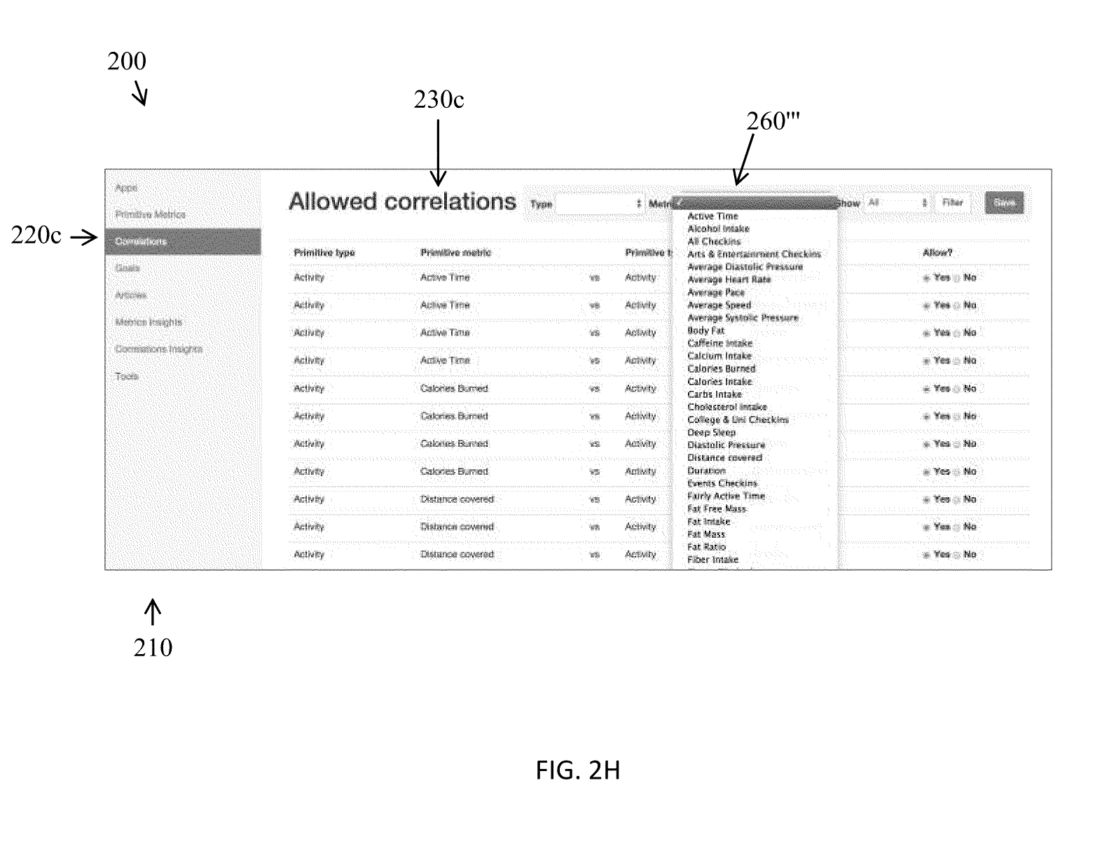

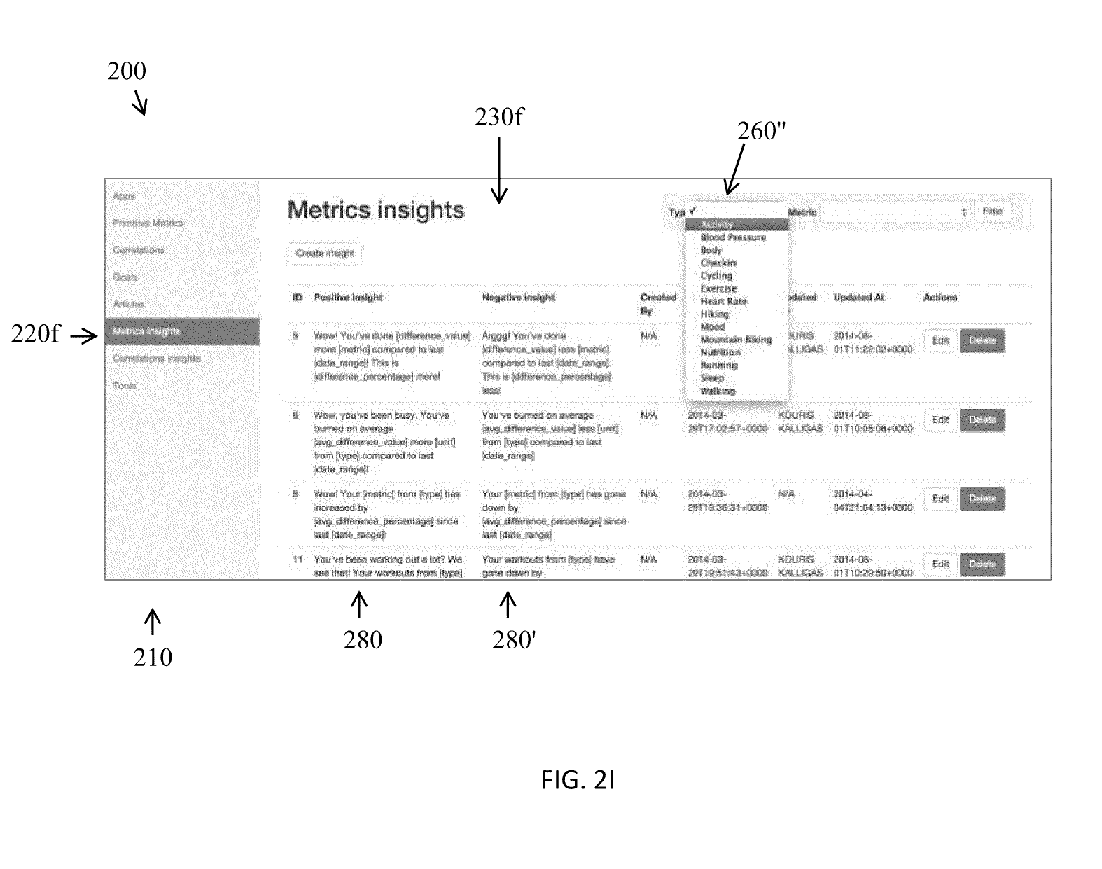

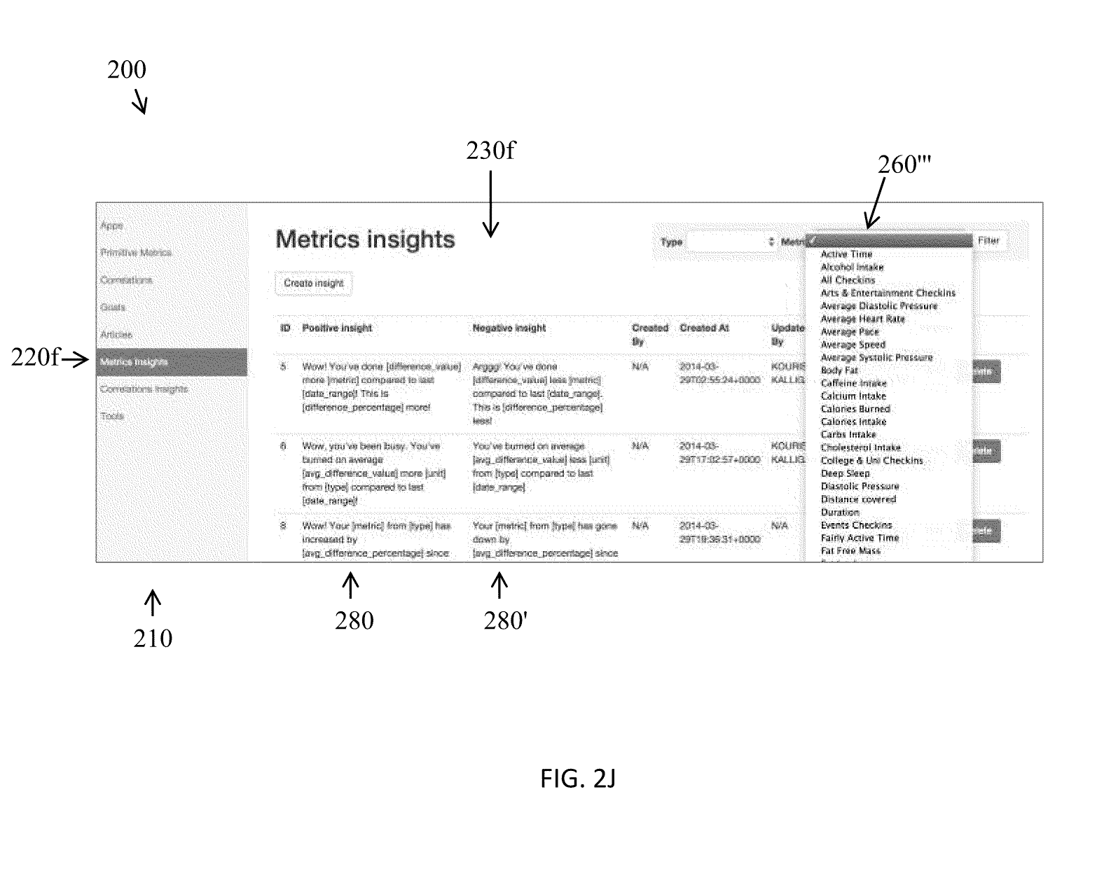

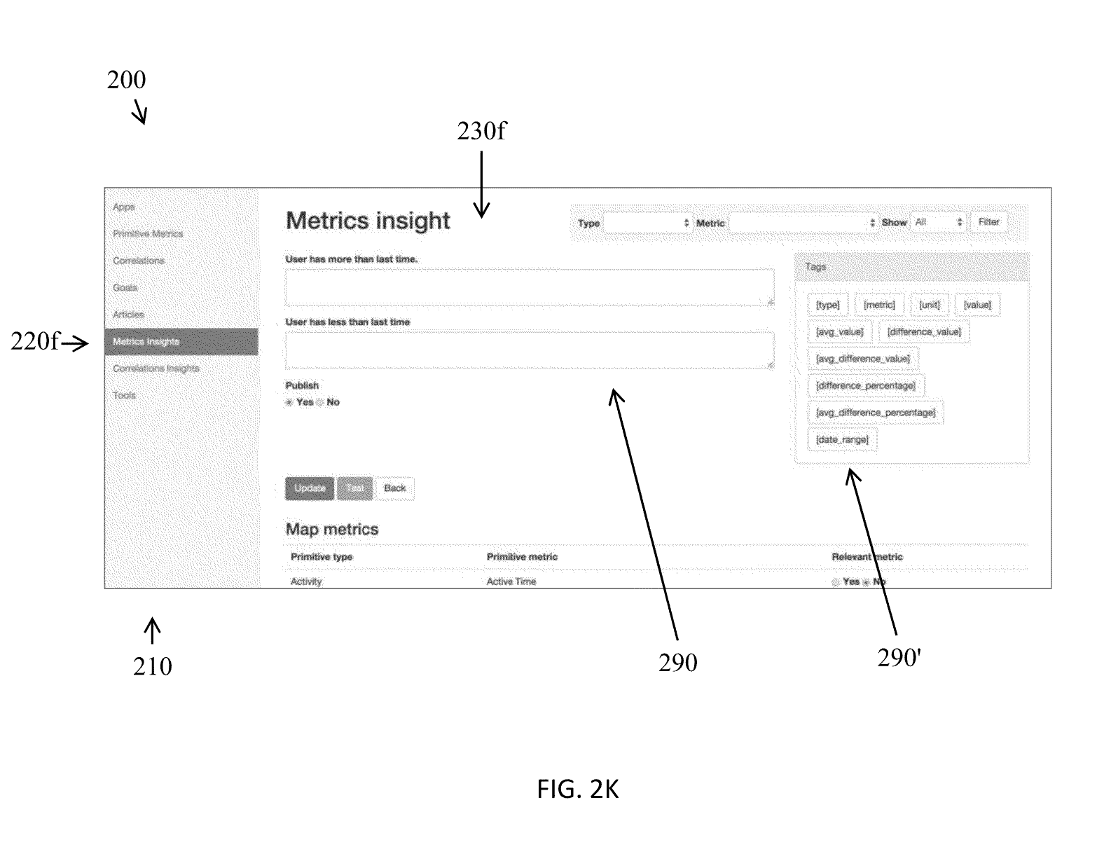

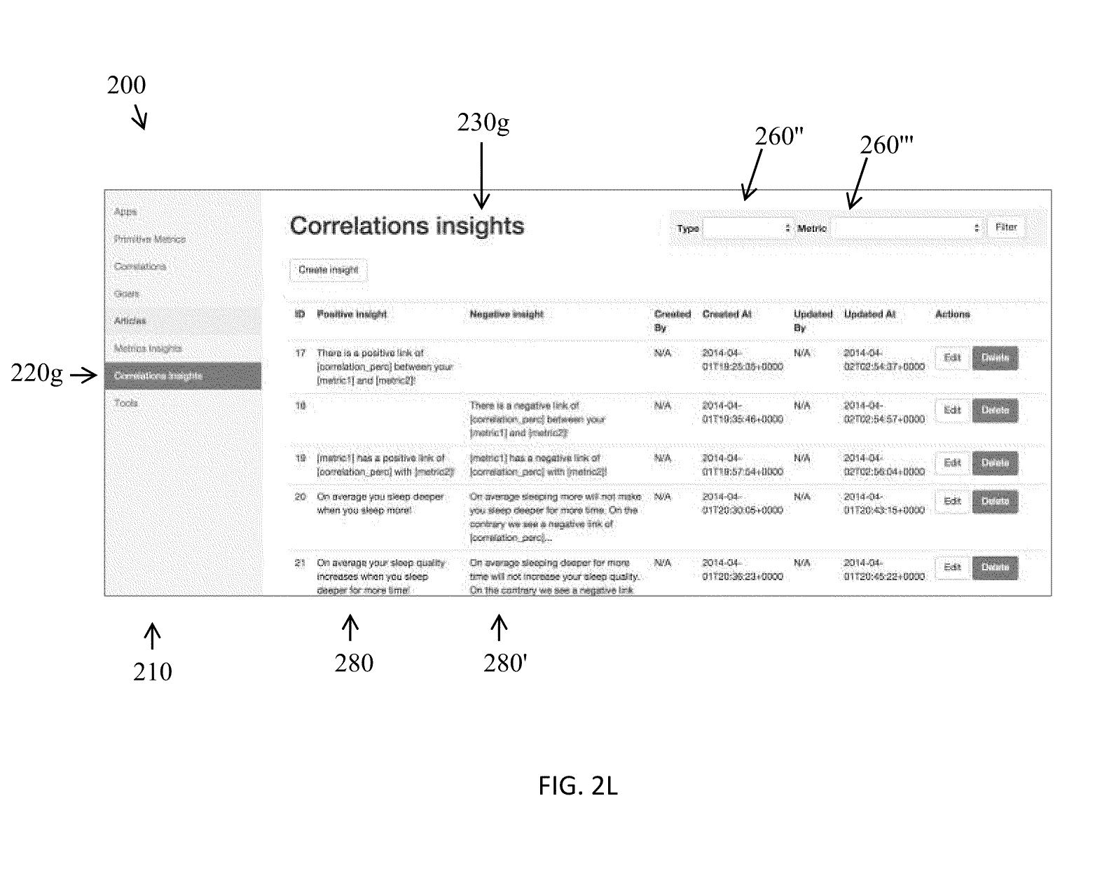

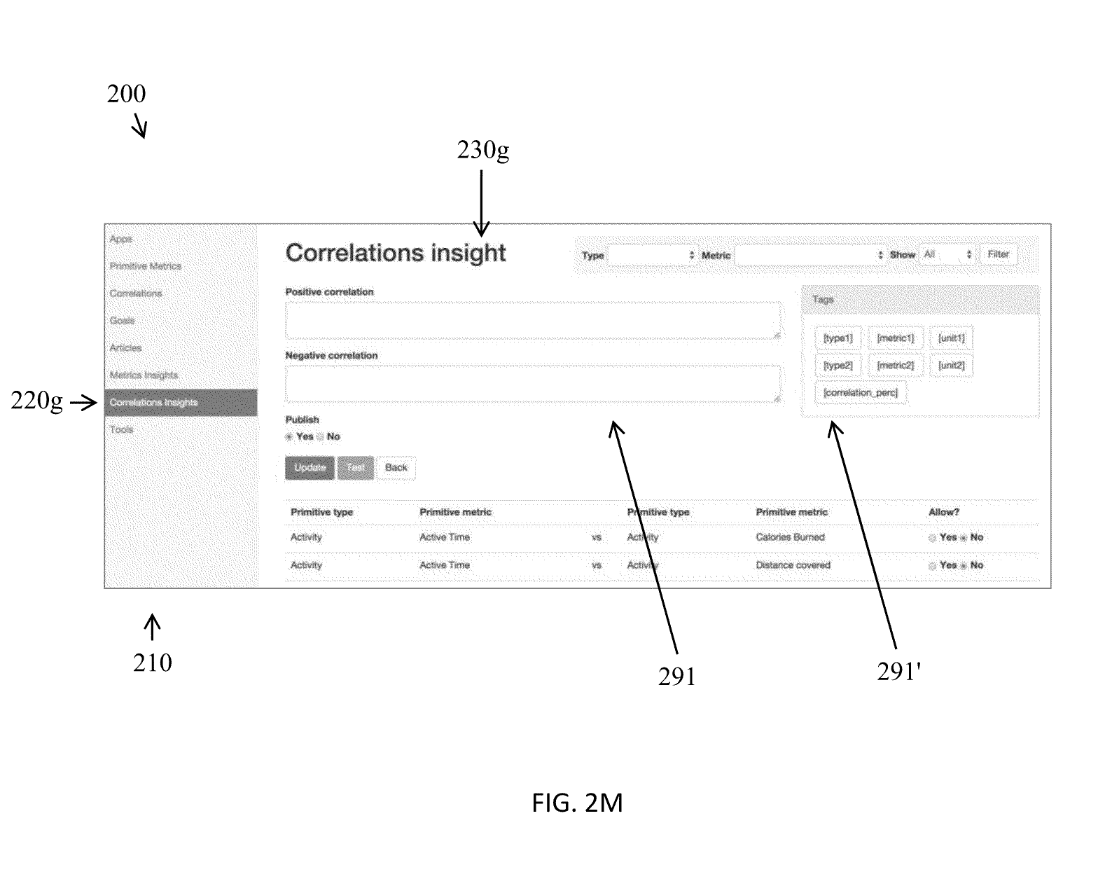

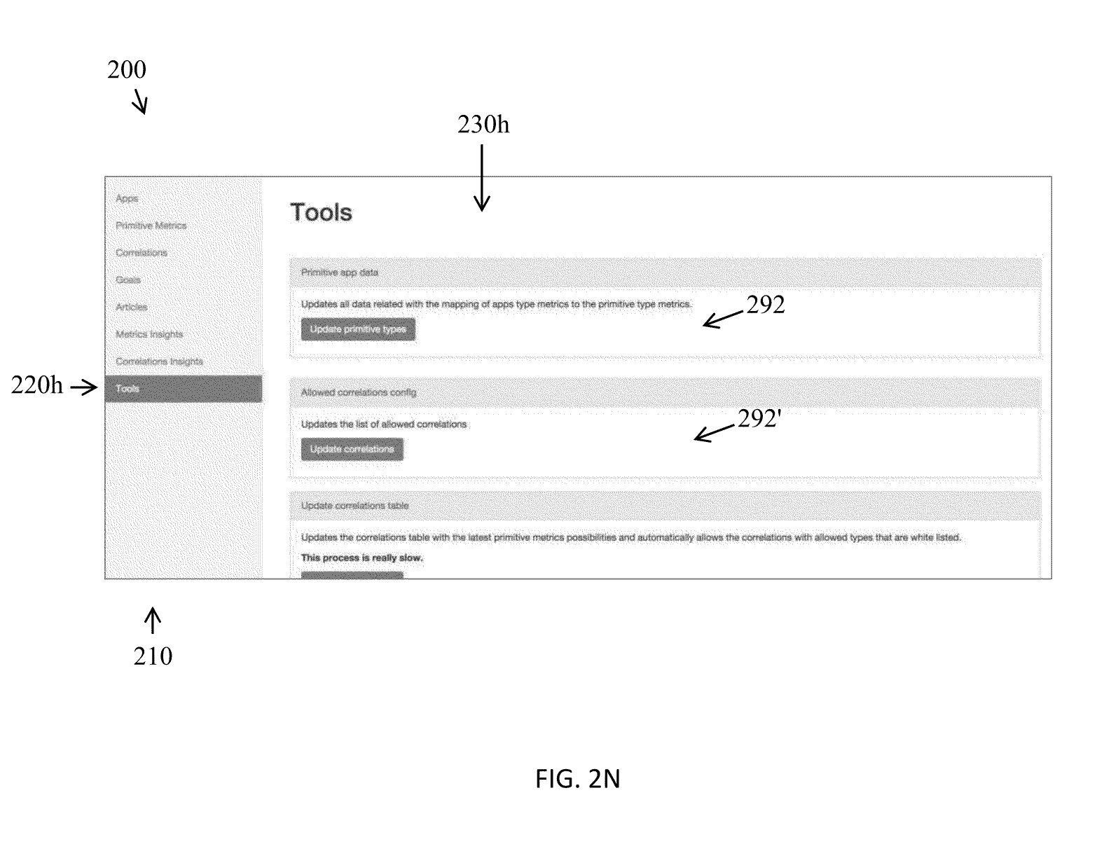

FIGS. 2A to 2N show user interface(s) 200 for a server application to manage complementary client application(s) to track, normalize, and/or correlate health and wellness metrics from various third-party applications. This server application will typically be complementary to the client application(s) described above. Using the server application, an administrator may select which third-party health and wellness application(s) the client application collects information and/or metrics from, how such information/or metrics are interpreted or correlated, and what tips, insights, informative articles, and/or action items are provided by the client application in response.

The left-hand side of the user interface(s) may show a main menu bar 210 which includes buttons 220 to access various sub-menus 230 which are shown on the center and right-hand side of the user interface 220. The sub-menus 230 may include a sub-menu to select third-party application(s) (accessible through Apps button 220a), manage primitive metrics (accessible through Primitive Metrics button 220b), manage correlations (accessible through Correlations button 220c), determine goals (accessible through Goals button 220d), provide informative articles (accessible through Articles button 220e), provide insights from the health and wellness metric(s) (accessible through Metric Insights button 2200, provide insights from the correlation of the metrics (accessible through Correlation Insights button 220g), and access settings and other tools (accessible through Tools button 220h). Each sub-menu 230 may comprise one or more tabs, each of which may include one or more buttons and/or inputs to adjust various settings or enter data.

FIG. 2A shows the user interface 200 with the Apps sub-menu 230a selected with button 220a to select or map one or more third-party health and wellness services and/or application(s) for the client application to interface with. The Apps sub-menu 230a many include a drop-down menu 250 through which the third-party services and/or application(s) may be selected. Examples of such applications may include Apple HealthKit, BodyMedia Fit, Cardiio, Facebook, Calorie Counter by FatSecret, FitBit, Foursquare, iHealth, Jawbone, Magellan GPS or Roadmate, Run with May My Run, Moodpanda, Moves, Runkeeper, Sleep as Android, Sleep Cycle, Strava, and WiThings Apps, to name a few.

FIG. 2B shows the Apps sub-menu 230a. The Apps sub-menu 230a may be used to select an exemplary third-party service and/or application. The Apps sub-menu 230a may include a tab 240a for mapping the third-party application to primitive metric(s) 260, a tab 240a′ for updating data for the third-party application, and a tab 240a″ for updating data related with the mapping of third-party application metric(s) 260 to primitive metric(s) 260a′. As shown in FIG. 2B, to map the third-party application metric(s) 260 to primitive metric(s) 260″, the third-party application metric(s) 260 may be displayed and sorted by type, unit, and related primitive metric(s). The unit and/or primitive metric(s) type used may be user selected.

FIGS. 2C-2F shows the Primitive Metrics sub-menu 230b. The Primitive Metrics sub-menu 230b may include a tab 240b to select primitive metrics, a tab 240b′ to select units used, and a tab 240b″ to select default targets for the primitive metrics.

FIG. 2C shows the Metrics sub-menu 230b and Metrics tab 240b. The Metrics sub-tab 240b may be used to edit or delete data entries for the primitive metrics. On the top right-hand corner, a filter may be provided to select the primitive metric type (drop-down menu 260″) and primitive metric (drop-down menu 260′) to be edited or deleted. Metric types include, but are not limited to, activity levels, blood pressure, body type, body mass index, check-in times, heart rate, exercise levels, mood, nutrition, sleep, and various exercise types such as cycling, mountain biking, running, and walking.

FIG. 2D shows the Metrics sub-menu 230b and Metrics tab 240a as well as the drop-down filter menu 260′″ which may be used to select one or more primitive metrics. Exemplary primitive metric categories or types are shown by the drop-down menu 260′. New primitive metric types and primitive metrics may be entered in addition to the default primitive metric types and primitive metrics already provided.

FIG. 2E show the Metrics sub-menu 230b and Units tab 240b′ which may be used to select the units to be used with each of the primitive metrics 260′.

FIG. 2F show the Metrics sub-menu 230b and Default targets tab 240b″, which may be used to enter the default user targets for the various primitive metric(s) 260′. For example, this sub-menu may be used to select the target amount of physical activity for the user who may track whether he or she has reached this target with the complementary client application.

FIGS. 2G and 2H show the Correlations sub-menu 230c accessible by selecting button 220c, which may be used to select a first primitive metric type and primitive metric to correlate with a second primitive metric type and primitive metric. On the top right-hand side of the user interface 200, a filter may be provided to select for display the primitive metric type(s) 260″, as shown by FIG. 2G, and the primitive metric(s) 260′, as shown by FIG. 2H.

FIGS. 2I to 2K show the Metric Insights sub-menu 230f which may be used to enter various tips and insights based on one or more primitive metrics. The tips and insights may be categorized into positive insights 280 and negative insights 280′. The tips and insights may be created, edited, and/or deleted. On the top right-hand side of the user interface, a filter may be provided to select for display the primitive metric type(s) 260″, as shown by FIG. 2I, and the primitive metric(s) 260′″, as shown by FIG. 2J.

FIG. 2K shows the Metric Insights sub-menu 230f and a further sub-menu for creating a new tip and insight based on primitive metric type(s) and/or a primitive metric(s). The creation sub-menu many include boxes for text entry 290 and generic tags 290′ which may be used to display specific primitive metric quantities to the user. The administrator may hover over the generic tabs 290′ to be displayed further information regarding the tag.

FIGS. 2L and 2M show the Correlation Insights sub-menu 230g which may be used to enter various tips and insights based on the correlations between two or more primitive metrics. The tips and insights may be categorized into positive insights 280 and negative insights 280′. The tips and insights may be created, edited, and/or deleted. On the top right-hand side of the user interface, a filter may be provided to select for display the primitive metric type(s) 260″ and the primitive metric(s) 260′″, similarly to the Metrics Insights sub-menu 220f.

FIG. 2M shows a further sub-menu within the Correlation Insights sub-menu 230g for creating a new tip and insight based on the correlations of the primitive metrics. The creation sub-menu many include boxes for text entry 291 and generic tags 291′ which may be used to display specific primitive metric quantities to the user. The administrator may hover over the generic tabs 291′ to be displayed further information regarding the tag.

FIG. 2N show the Tools sub-menu 230h. The Tools sub-menu 230h may include a selection 292 to update data for the client application and/or the third-party applications (e.g., mapping data related with the mapping of the third-party applications metrics to the primitive metrics), a selection 292′ for updating the list of allowed primitive metric correlations, and/or a selection 292″ for updating the correlations table with the latest primitive metric possibilities and automatically allowing correlations with the allowed types.

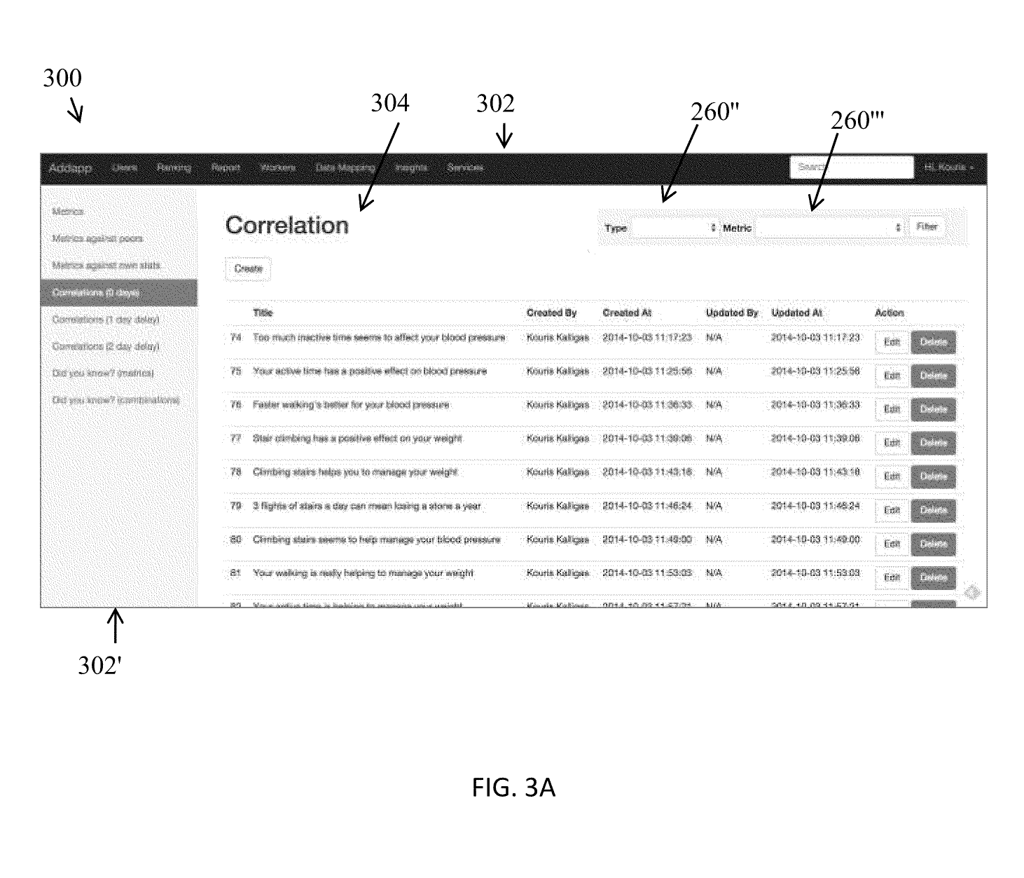

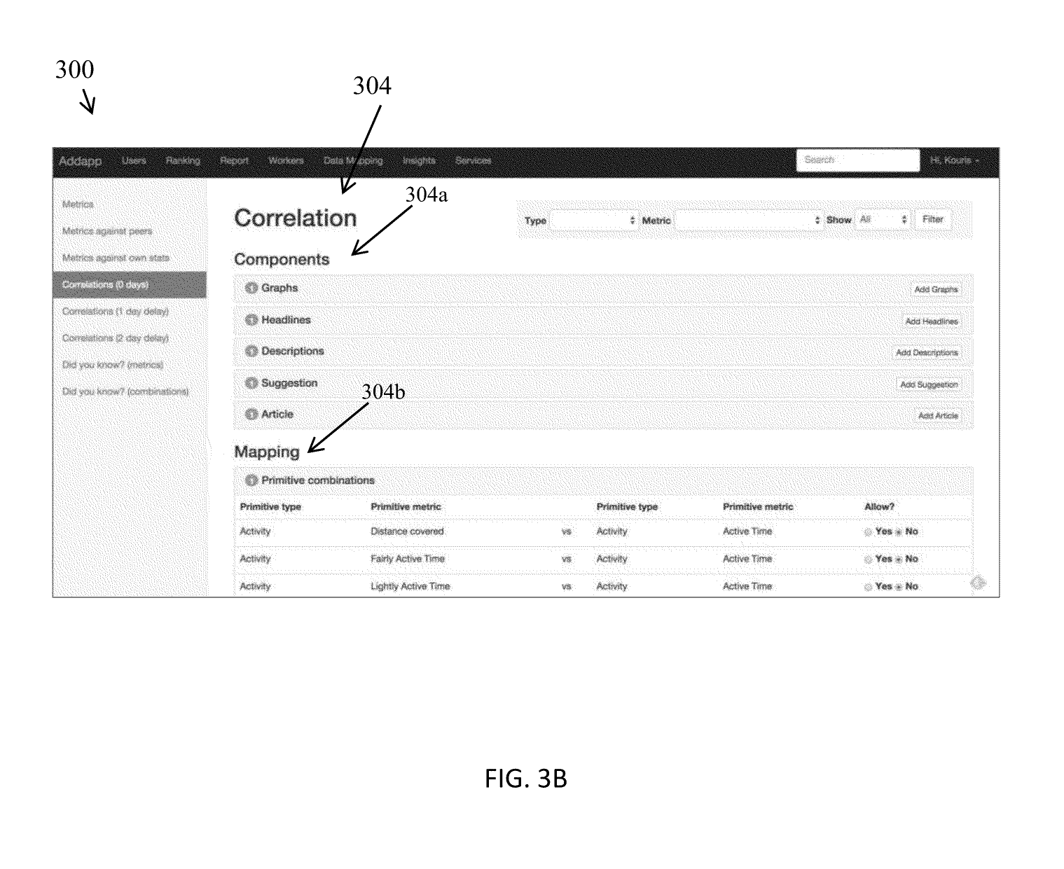

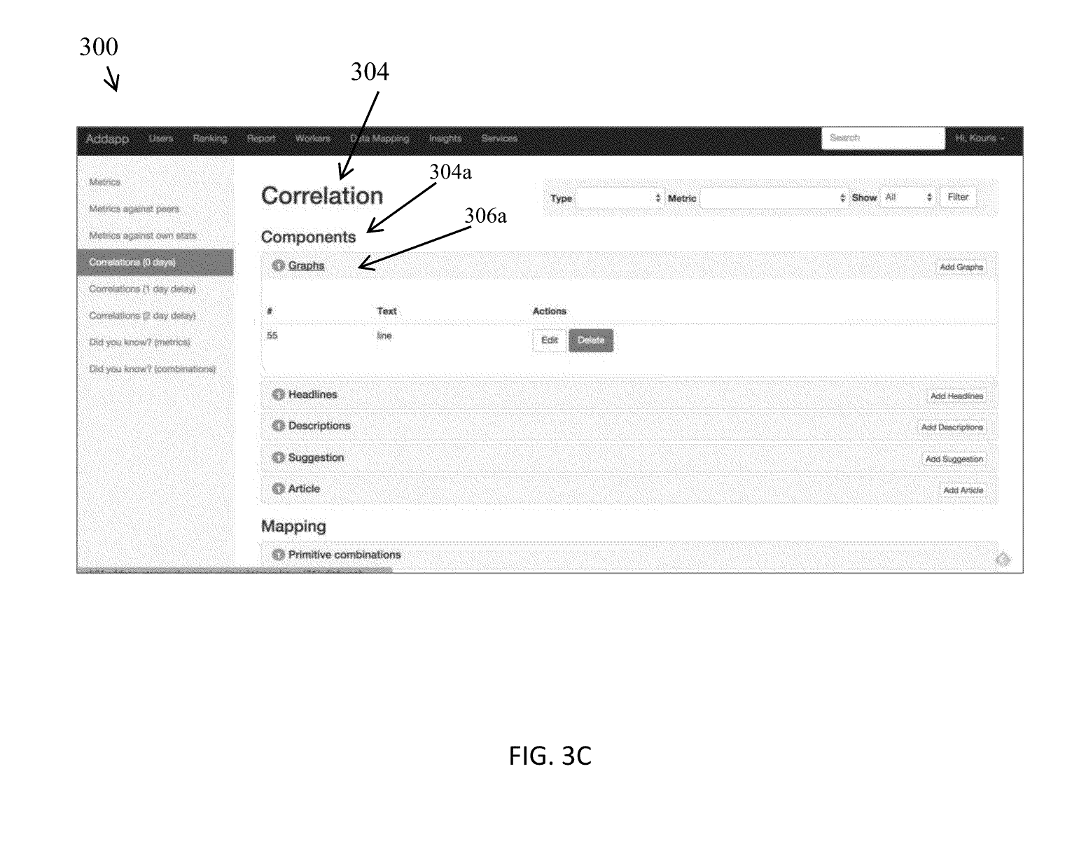

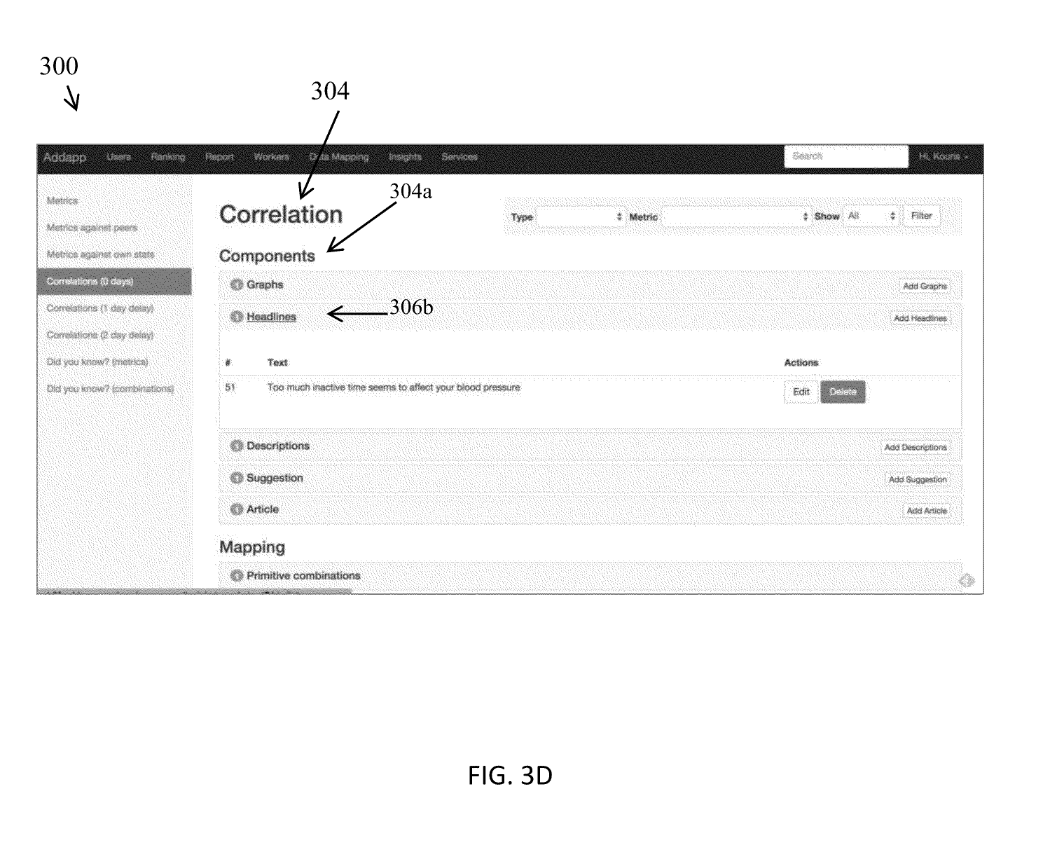

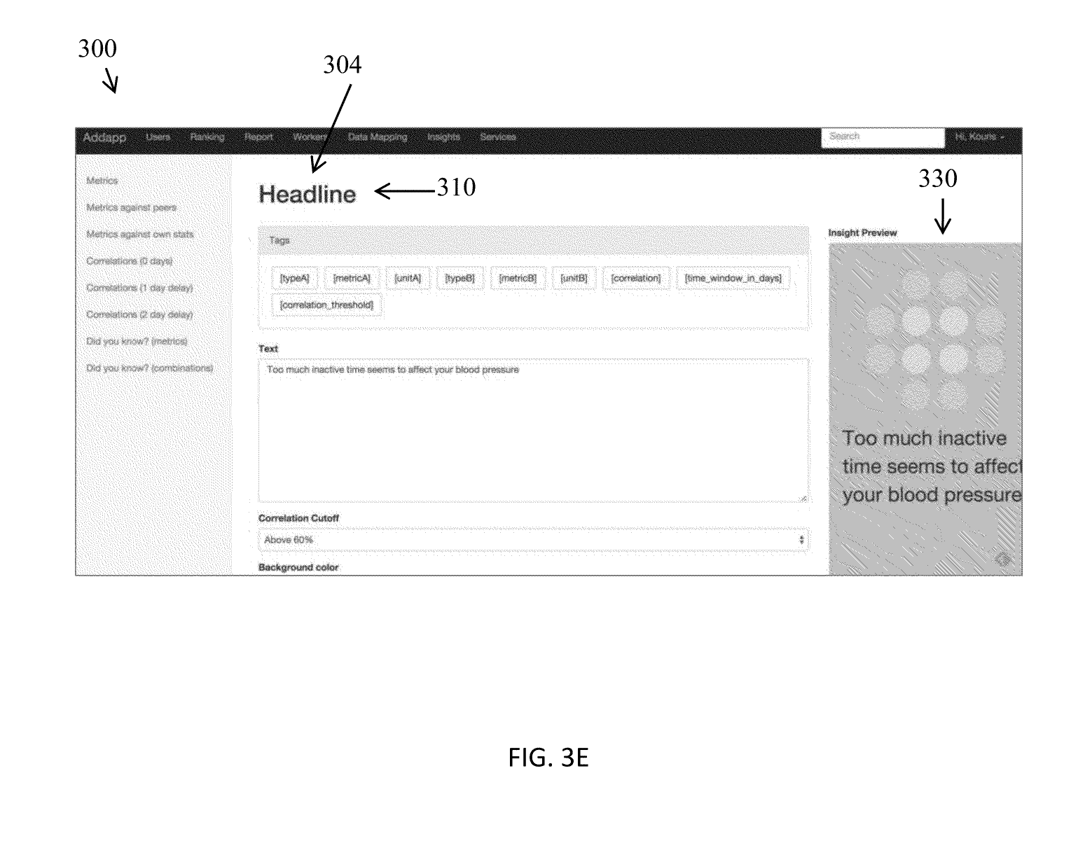

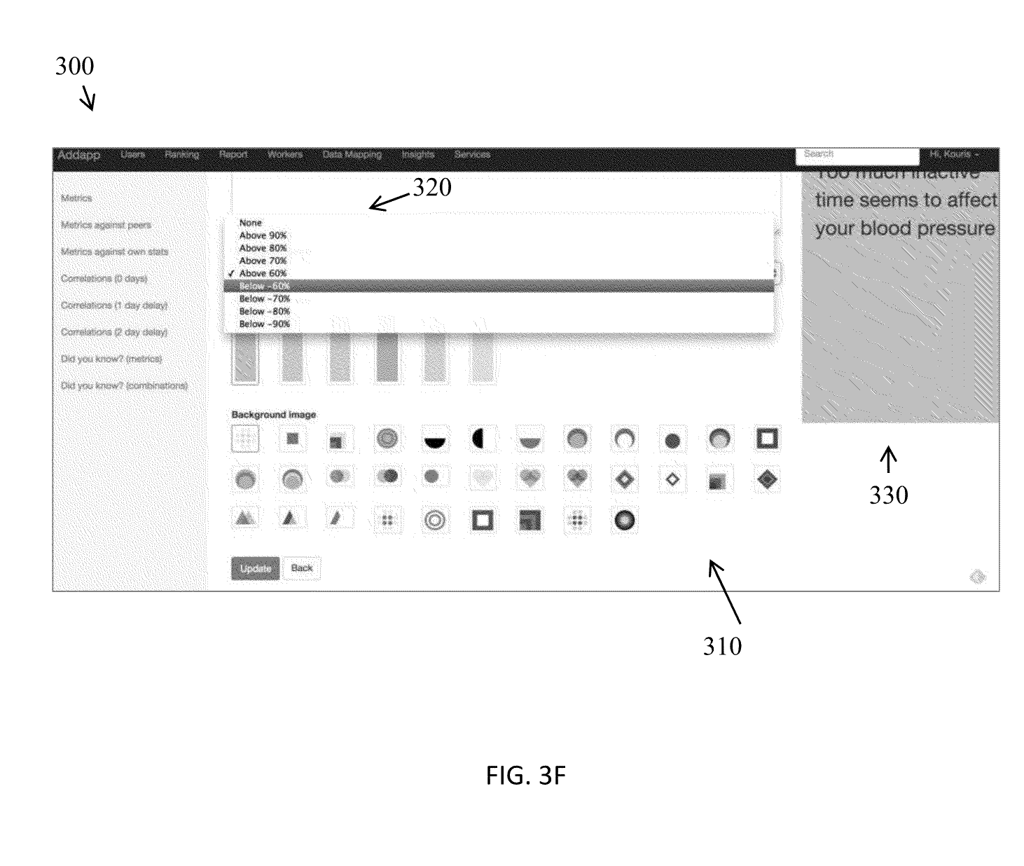

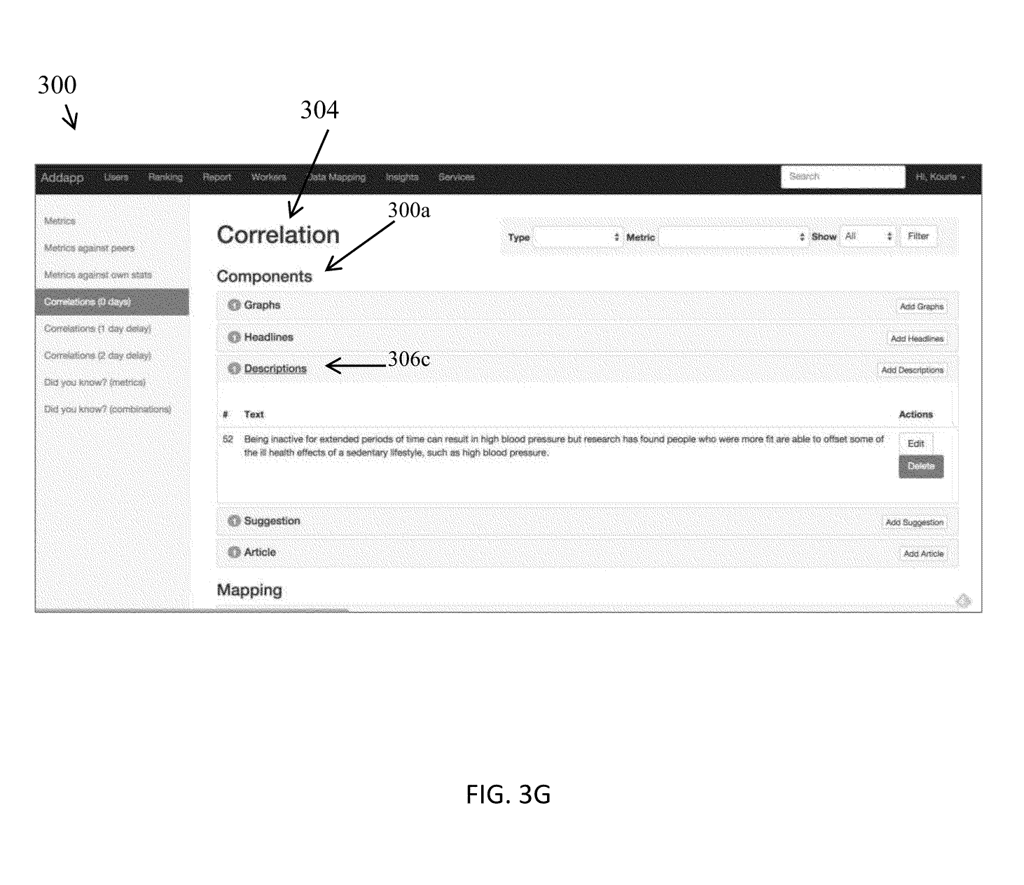

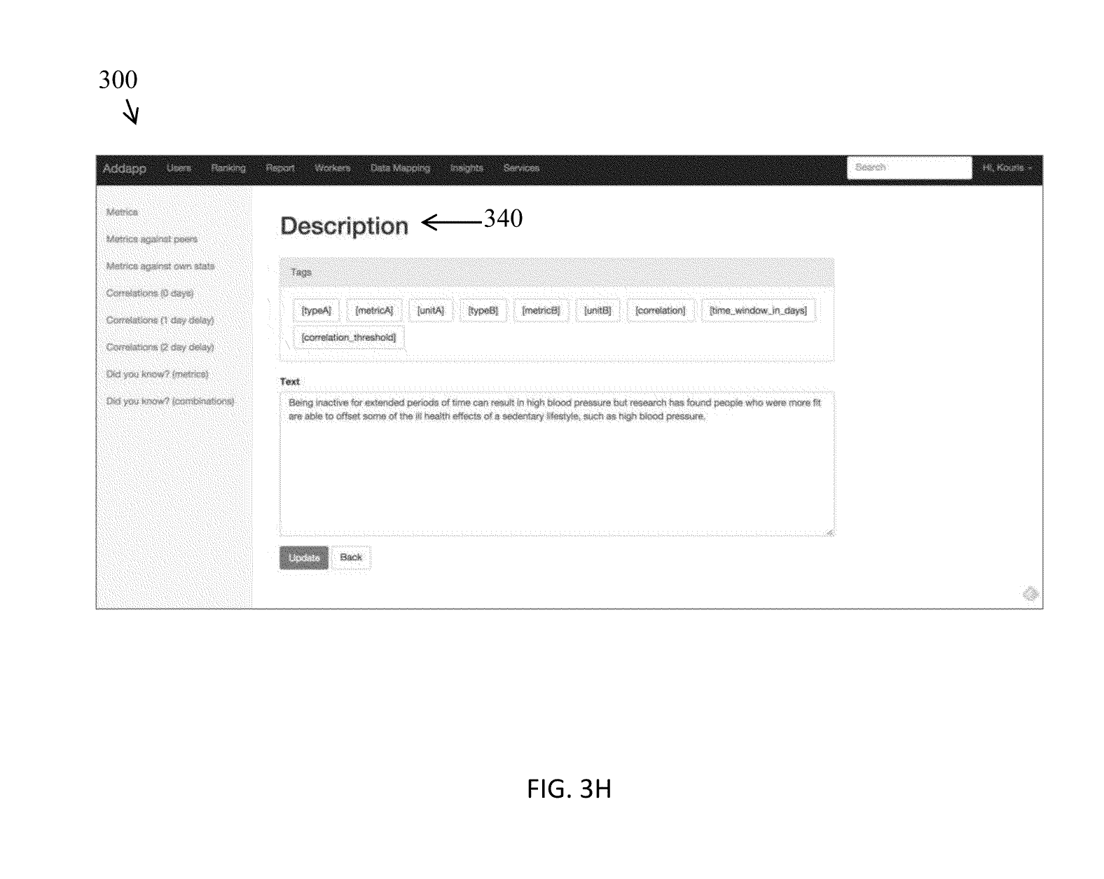

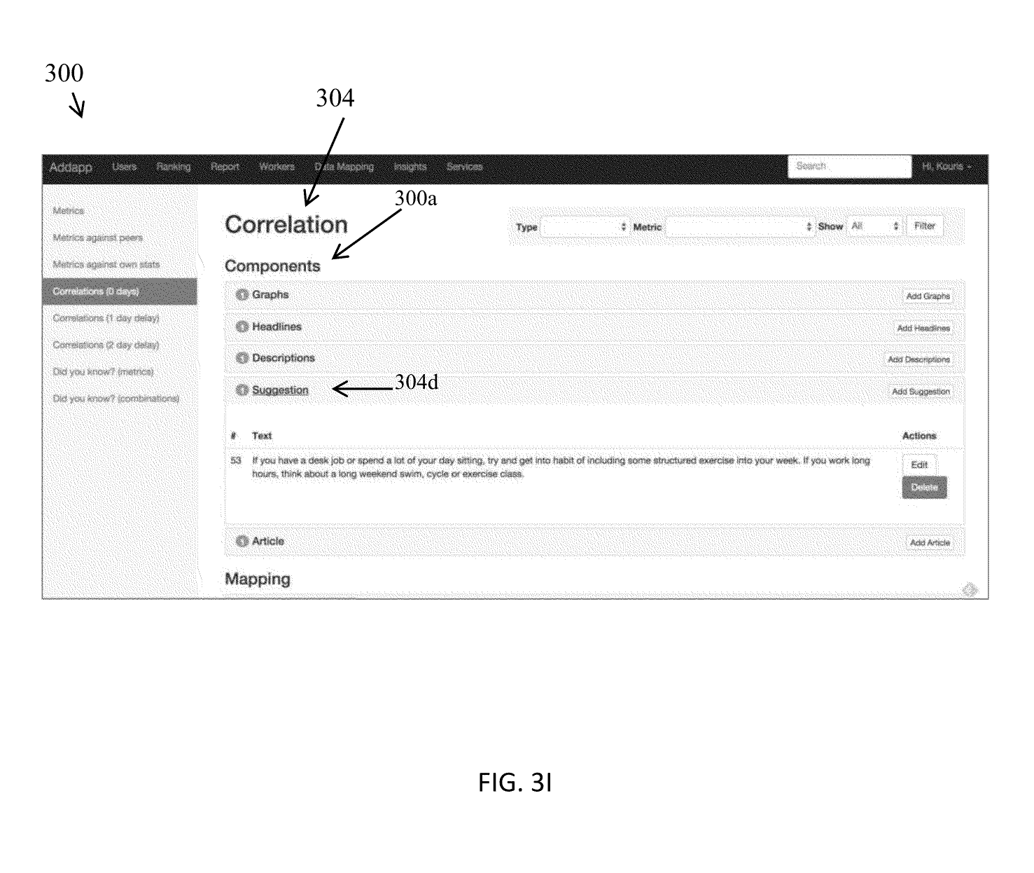

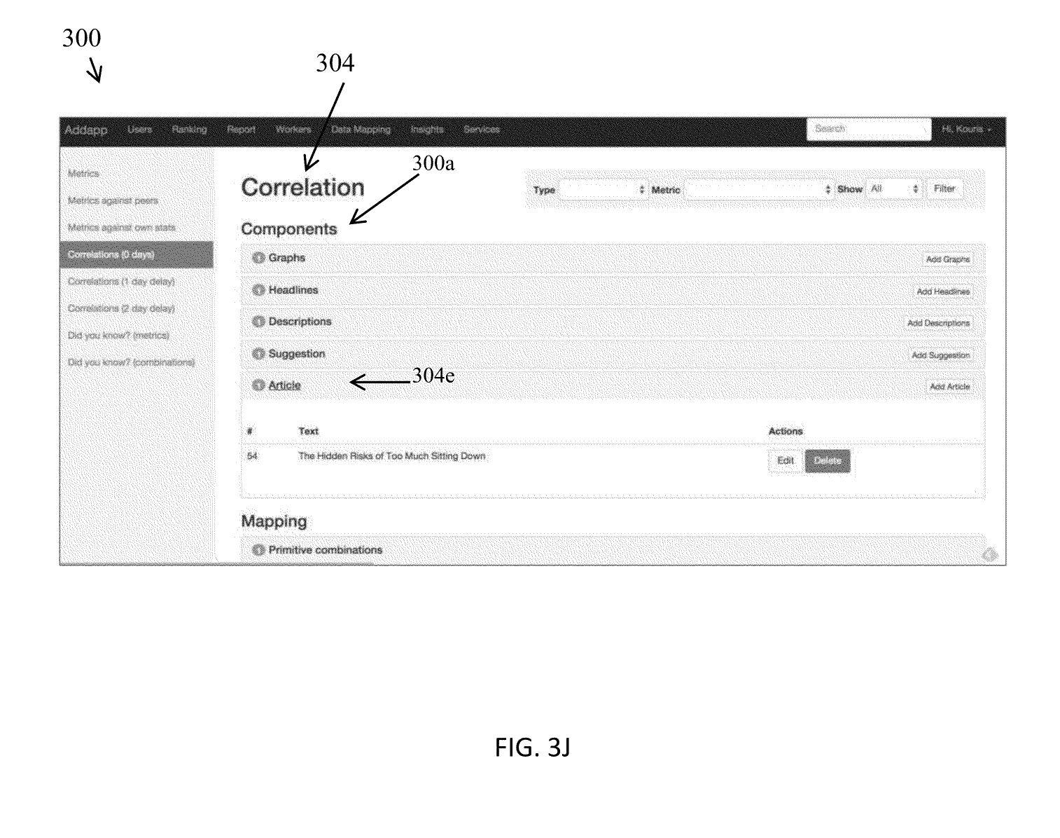

FIGS. 3A to 3J show user interface(s) 300 for the server application to manage complementary client application(s) to provides tips, insights, instructions, and/or informative articles based on health and wellness metrics from the various third-party application(s). One or more menu options from the left-hand side main menu 220 of the user interface(s) 200 of FIGS. 2A to 2N may be provided as a top menu-bar 302 and/or the left-hand side main menu bar 302′. As shown by the left-hand side main menu, the user interface(s) 300 of FIGS. 3A to 3J may be used to manage and adjust the primitive metric(s) used, how the primitive metric(s) relate to those of peers, how the primitive metric(s) relate to prior measurements, the information provided based on the primitive metric correlations (on a 0, 1, 2, or more day delay), and the insights and tips to be provided.

FIG. 3A shows a Correlation sub-menu 304 which may be used to create, edit, or delete various tips and/or insights based on primitive metric correlations. A filter menu on the top right-hand side may be used to select the tips and/or insights for display based on its primitive metric type 260″ and the primitive metric 260′″.

FIGS. 3B to 3J shows the Correlation sub-menu 304 which may be used to edit the tip and/or insight provided to the user by the client application.

FIG. 3B shows a sub-menu which may be used to edit the information shown by a tip and/or insight. On the Components sub-menu 304a, various components for the tip and/or insight, such as graphs, headlines, descriptions, suggestions, and/or informative articles, may be selected. On the Mapping sub-menu 304b, various primitive metric correlations may also be selected.

FIG. 3C shows the Components sub-menu 304 and its Graphs sub-menu 306a. The Graphs sub-menu 306a may used to add, edit, and/or delete various graphs showing the primitive metrics. For example, different graph types such as a line graph or a column graph may be selected.

FIG. 3D shows the Components sub-menu 304a and its Headlines sub-menu 306b. The Headlines sub-menu 306b may be used to add, edit, and/or delete the headlines for an insight and/or tip.

FIG. 3E shows a further Headlines sub-menu 310 which may be used to edit the headline for the insight and/or tip. This sub-menu may be accessed through the edit button of the Headlines sub-menu 306b shown by FIG. 3D.

FIG. 3F shows the bottom portion of further Headlines sub-menu 310. A drop-down menu 320 may be provided for the administrator to select the primitive metric correlation threshold to display the insight and/or tip. The background color and/or image may be selected as well. A preview 330 of the insight and/or tip may be shown by on the right-hand side as shown in FIGS. 3E and 3F. The insight and/or tip may be similar to those shown and described above by FIGS. 1J to 1M.

FIG. 3G shows the Correlation sub-menu 304 and its Descriptions sub-menu 306c. This Descriptions sub-menu 306c may be used to create, edit, or delete descriptive text provided by a selected insight and/or tip. The descriptive text may be provided by the detailed insight and/or tip shown and described above by FIGS. 1N and 1O.

FIG. 3H show a sub-menu 340 which may be used to edit the text description for the detailed insight and/or tip. This sub-menu 340 may be accessed through the edit button of the Headlines sub-menu 306b shown by FIG. 3G.

FIG. 3I shows the Correlations sub-menu 304 and its Suggestion sub-menu 304d. This Suggestions sub-menu 304d may be used to create, edit, or delete suggestive text provided by the detailed insight and/or tip. The suggestive text may suggest to the user a course of action based on the primitive metric correlation. The suggestive text may be provided by the detailed insight and/or tip.

FIG. 3J shows the Correlation sub-menu 304 and its Article sub-menu 304e. This Article sub-menu may be used to create, edit, or delete a hyperlink to an informative article related to the primitive metric correlation. The hyperlink may be provided by the detailed insight and/or tip.

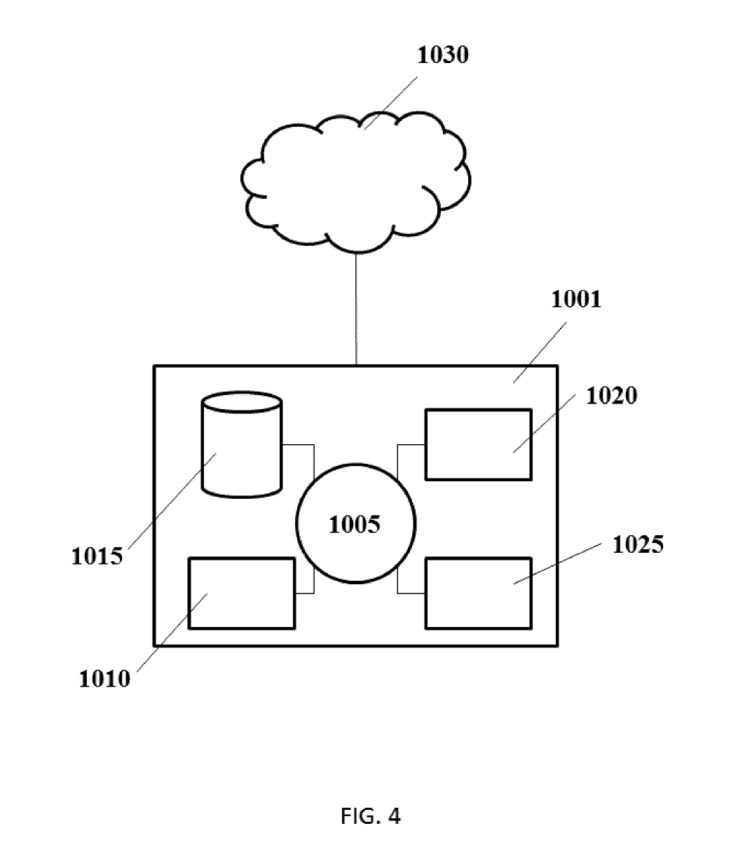

The present disclosure provides computer control systems that are programmed to implement methods of the present disclosure. FIG. 4 shows a computer system 1001 that is programmed or otherwise configured to manage health and wellness metrics and provide insights and/or tips therefrom as described herein. The computer system 1001 can regulate various aspects of client and/or server applications of the present disclosure, such as, for example, the selection of the third-party applications, primitive metric(s), and primitive metric correlation(s). The computer system 1001 may comprise a mobile computing device as described herein.

The computer system 1001 includes a central processing unit (CPU, also “processor” and “computer processor” herein) 1005, which can be a single core or multi core processor, or a plurality of processors for parallel processing. The computer system 1001 also includes memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage and/or electronic display adapters. The memory 1010, storage unit 1015, interface 1020, and peripheral devices 1025 are in communication with the CPU 1005 through a communication bus (solid lines), such as a motherboard. The storage unit 1015 can be a data storage unit (or data repository) for storing data. The computer system 1001 can be operatively coupled to a computer network (“network”) 1030 with the aid of the communication interface 1020. The network 1030 can be the Internet, an internet and/or extranet, or an intranet and/or extranet that is in communication with the Internet. The network 1030 in some cases is a telecommunication and/or data network. The network 1030 can include one or more computer servers, which can enable distributed computing, such as cloud computing. The network 1030, in some cases with the aid of the computer system 1001, can implement a peer-to-peer network, which may enable devices coupled to the computer system 1001 to behave as a client or a server.

The CPU 1005 can execute a sequence of machine-readable instructions, which can be embodied in a program or software. The instructions may be stored in a memory location, such as the memory 1010. The instructions can be directed to the CPU 1005, which can subsequently program or otherwise configure the CPU 1005 to implement methods of the present disclosure. Examples of operations performed by the CPU 1005 can include fetch, decode, execute, and write-back.

The CPU 1005 can be part of a circuit, such as an integrated circuit. One or more other components of the system 1001 can be included in the circuit. In some cases, the circuit is an application specific integrated circuit (ASIC).

The storage unit 1015 can store files, such as drivers, libraries and saved programs. The storage unit 1015 can store user data, e.g., user preferences and user programs. The computer system 1001 in some cases can include one or more additional data storage units that are external to the computer system 1001, such as located on a remote server that is in communication with the computer system 1001 through an intranet or the Internet.

The computer system 1001 can communicate with one or more remote computer systems through the network 1030. For instance, the computer system 1001 can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1001 via the network 1030. Through the network 1030, the computer system 1001 can access and take input from the server application as described herein, such as to select various primitive metric(s) and/or primitive metric correlation(s) for analysis and the provision of insights and/or tips as described herein. The server application may be downloaded and active on a remote server or remote computer system.

Methods as described herein can be implemented by way of machine (e.g., computer processor) executable code stored on an electronic storage location of the computer system 1001, such as, for example, on the memory 1010 or electronic storage unit 1015. The machine executable or machine readable code can be provided in the form of software. During use, the code can be executed by the processor 1005. In some cases, the code can be retrieved from the storage unit 1015 and stored on the memory 1010 for ready access by the processor 1005. In some situations, the electronic storage unit 1015 can be precluded, and machine-executable instructions are stored on memory 1010.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1001 can include or be in communication with an electronic display that comprises a user interface (UI) for providing, for example, the user interface described above with reference to FIGS. 1A to 1O. Examples of UI's include, without limitation, a graphical user interface (GUI) and web-based user interface.

Methods and systems of the present disclosure can be implemented by way of one or more algorithms. An algorithm can be implemented by way of software upon execution by one or more computer processors. In some examples, an algorithm for managing health and wellness metrics comprises various one or more steps such as selecting one or more third-party services and/or applications to interface with, selecting informational categories to draw metrics from the third-party services and/or applications, drawing the selected metrics, normalizing the metrics into primitive metrics, correlating the primitive metrics, and providing insights and/or tips to the user based on the primitive metric(s) and/or primitive metric correlation(s).

While preferred embodiments of the present disclosure have been shown and described herein, it will be obvious to those skilled in the art that such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions will now occur to those skilled in the art without departing from the scope of the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations or equivalents. It is intended that the following claims define the scope of the invention and that methods and structures within the scope of these claims and their equivalents be covered thereby.

What is claimed is:

1. A computer implemented method for managing user health and wellness data, the method comprising:
receiving, with a computing device of a user, a first health and wellness metric collected from a first application downloaded onto the computing device;
receiving, with the computing device, a second health and wellness metric collected from one or more of the first application or a second application downloaded onto the computing device, the first health and wellness metric being different from the second health and wellness metric and the second application being different from the first application;
normalizing the first health and wellness metric into a first primitive metric;
normalizing the second health and wellness metric into a second primitive metric;
correlating the first and second primitive metrics; and
displaying to the user, on a display of the computing device, one or more of a graph for a health and wellness metric, a health and wellness tip, a health and wellness insight, a user action for improved health and wellness, or a health and wellness informative article in response to the correlation between the first and second primitive metrics.

2. The method of claim 1, wherein the computing device comprises a tablet computer, a mobile computing device, a smartphone, a wearable computing device, or an implantable computing device.

3. The method of claim 1, wherein one or more of the first or second application is downloaded from an online application distribution platform.

4. The method of claim 1, wherein one or more of the first or second primitive metric comprises activity level, blood pressure, body type, body mass index, check-in time, heart rate, exercise level, mood, nutrition, sleep, or exercise type.

5. The method of claim 1, wherein the first primitive metric and the second primitive metric are of the same metric type.

6. The method of claim 1, wherein the first primitive metric and the second primitive metric are of different metric types.

7. The method of claim 1, further comprising generating one or more of the graph of the health and wellness metric, the health and wellness tip, the health and wellness insight, the user action of improved health and wellness, or the health and wellness informative article in response to correlating the first and second primitive metrics.

8. The method of claim 1, further comprising receiving a correlation setting instruction with the computing device, wherein the first and second primitive metrics are correlated in response to the correlation setting instruction.

9. The method of claim 8, wherein the correlation setting instruction is received from one or more of a user input or a server application.

10. The method of claim 1, further comprising uploading one or more of the first health and wellness metric, the second health and wellness metric, the first primitive metric, the second primitive metric, or the correlation of the first and second primitive metrics to a server application in communication with the computing device.

11. The method of claim 10, wherein the server application saves the uploaded one or more of the first health and wellness metric, the second health and wellness metric, the first primitive metric, the second primitive metric, or the correlation of the first and second primitive metrics.

12. The method of claim 1, further comprising receiving normalization setting instructions with the computing device, wherein one or more of the first or second health and wellness metrics are normalized into the first or second primitive metrics, respectively, in response to the normalization setting instruction.

13. The method of claim 12, wherein the normalization setting instruction is received from one or more of a user input or a server application.

14. A computer implemented method for managing user health and wellness data, the method comprising:
selecting, with a computing device, a first application, the first application being configured for download onto a remote computing device;
selecting, with the computing device, a second application, the second application being configured for download onto the remote computing device and being different from the first application;
selecting, with the computing device, a first primitive metric, the first primitive metric being configured to be normalized from a first health and wellness metric from the first application using the computing device;
selecting, with the computing device, a second primitive metric, the second primitive metric being configured to be normalized from a second health and wellness metric from one or more of the first application or second application using the computing device;
inputting, into the computing device, one or more of a target goal for first or second primitive metrics, a correlation parameter for the first and second primitive metrics, a health and wellness tip, a health and wellness insight, a user action for improved health and wellness, or a health and wellness informative article in response to the first or second primitive metric.

15. The method of claim 14, wherein the computing device comprises a server computer.

16. The method of claim 14, wherein one or more of the first or second application is configured to be downloaded from an online application distribution platform.

17. The method of claim 14, wherein one or more of the first or second primitive metric comprises activity level, blood pressure, body type, body mass index, check-in time, heart rate, exercise level, mood, nutrition, sleep, or exercise type.

18. The method of claim 14, wherein the first primitive metric and the second primitive metric are of the same metric type.

19. The method of claim 14, wherein the first primitive metric and the second primitive metric are of different metric types.

20. The method of claim 14, further comprising downloading onto the remote computing device the one or more of the target goal for the first or second primitive metrics, the correlation parameter for the first and second primitive metrics, the health and wellness tip, the health and wellness insight, the user action for improved health and wellness, or the health and wellness informative article.

21. The method of claim 14, wherein the remote computing device comprises a tablet computer, a mobile computing device, a smartphone, a wearable computing device, or an implantable computing device.
